(19) United States
(12) Patent Application Publication
(10) Pub. No.: US 2021/0305869 A1
(43) Pub. Date: Sep. 30, 2021

(54) ROTARY ELECTRIC MACHINE

(71) Applicant: AISIN SEIKI KABUSHIKI KAISHA, Kariya-shi (JP)

(72) Inventor: Masafumi SAKUMA, Kariya-shi (JP)

(73) Assignee: AISIN SEIKI KABUSHIKI KAISHA, Kariya-shi (JP)

(21) Appl. No.: 17/208,469

(22) Filed: Mar. 22, 2021

(30) Foreign Application Priority Data
Mar. 27, 2020 (JP) 2020-058641

(51) Int. Cl. H02K 3/28; H02K 1/27; H02K 21/14

(52) U.S. Cl. CPC H02K 3/28; H02K 2213/03; H02K 21/14; H02K 1/276

(57) ABSTRACT

A rotary electric machine includes a stator that has a plurality of slots accommodating a coil having a lap winding configuration made of a segment conductor, and a rotor that faces the stator and has a plurality of magnetic poles, and has a fractional slot configuration in which the number of slots per pole and phase is more than 1/2, and a denominator is equal to or more than 2 in an irreducible fraction expression. When the irreducible fraction expression of the number of slots per pole and phase is set as (a+b/c) where a indicates zero or a positive integer, and b and c indicate a positive integer and b<c, the coil for a laps is configured by an adjacent pole coil group, and the coil of a (a+1)th lap is configured by a continuous-pole coil group. The a laps are made in the same direction.

### CROSS REFERENCE TO RELATED APPLICATIONS

This application is based on and claims priority under 35 U.S.C. § 119 to Japanese Patent Application No. 2020-58641, filed on Mar. 27, 2020, the entire content of which is incorporated herein by reference.

### TECHNICAL FIELD

This disclosure relates to a rotary electric machine including a stator having a plurality of slots accommodating a coil made of a segment conductor and a rotor facing the stator and having a plurality of magnetic poles.

### BACKGROUND DISCUSSION

In the related art, a rotary electric machine as follows is known (for example, see JP 2012-16195 A and JP 2014-103707 A). The rotary electric machine includes a coil having a lap winding configuration made of segment conductors and has an integer slot configuration in which the number of slots per pole and phase, which is obtained by dividing the number of slots of a stator by the number of phases and the number of magnetic poles of a rotor, is a natural number.

The rotary electric machine disclosed in JP 2012-16195 A is formed by arranging 2n unit coils having a distributed winding configuration of being wound at predetermined slot intervals in a circumferential direction of the stator. One of two slots into which a first unit coil is inserted is the same as one of two slots into which an n-th unit coil is inserted. One of two slots into which a (n+1)th unit coil is inserted is the same as one of two slots into which a 2n-th unit coil is inserted. JP 2012-16195 A discloses that, with such a configuration, it is possible to reduce the potential difference between different unit coils arranged in the same slot to about the half the in-phase potential difference.

The rotary electric machine disclosed in JP 2014-103707 A uses a U-shaped conductor segment as a unit coil having a distributed winding configuration of being wound at predetermined slot intervals in the circumferential direction of the stator. The rotary electric machine has a shape in which the leg portion of the conductor segment is bent in a radial offset state. The leg portions of conductor segments adjacent to each other in the radial direction are electrically connected to each other. JP 2014-103707 A discloses that, with such a configuration, the conductor segment at the start of winding and the conductor segment at the end of the winding are arranged in the same slot without being adjacent to each other, and thus it is possible to reduce the maximum potential difference between the conductor segments.

A rotary electric machine that includes a coil made of segment conductors and has a fractional slot configuration in which, when the number of slots per pole and phase is expressed by an irreducible fraction, the denominator is equal to or more than 2 is known (for example, see JP 2008-172926 A). The technique disclosed in JP 2008-172926 A realizes a rotary electric machine having a fractional slot configuration in which segment conductors having different phases are mixed in one slot by forming the segment conductors in a wave winding configuration.

A rotary electric machine having a fractional slot configuration is useful because it is possible to realize the better torque ripple characteristics with a smaller number of slots than a rotary electric machine having an integer slot configuration. However, the techniques disclosed in JP 2012-16195 A and JP 2014-103707 A are rotary electric machines having an integer slot configuration. Thus, it is not possible to apply the techniques to rotary electric machines having a fractional slot configuration. Although the technique disclosed in JP 2008-172926 A is a rotary electric machine having a fractional slot configuration, this technique adopts a wave winding configuration in which a short-section pitch and a long-section pitch are repeated. Thus, the total coil length is longer than the lap winding configuration when the short-section pitch is mainly used. The manufacturing cost also increases.

Therefore, it is desired to realize a rotary electric machine having a fractional slot configuration using a segment conductor, with a lap winding configuration.

A need thus exists for a rotary electric machine which is not susceptible to the drawback mentioned above.

### SUMMARY

According to an aspect of this disclosure, a rotary electric machine includes a stator that has a plurality of slots accommodating a coil having a lap winding configuration made of a segment conductor, and a rotor that faces the stator and has a plurality of magnetic poles, and has a fractional slot configuration in which the number of slots per pole and phase, which is obtained by dividing the number of the slots of the stator by the number of phases and the number of the magnetic poles of the rotor, is more than ½, and a denominator is equal to or more than 2 in an irreducible fraction expression. When the irreducible fraction expression of the number of slots per pole and phase is set as (a+b/c) where a indicates zero or a positive integer, and b and c indicate a positive integer and b<c, the coil for a laps is configured by an adjacent pole coil group in which pole coils adjacent to each other in a circumferential direction are electrically and sequentially connected to each other while the pole coils are arranged to be adjacent to each other over an entire circumference of the stator, the pole coils of which the number is equal to the number of magnetic poles of the rotor, and the coil of a (a+1)th lap is configured by a continuous-pole coil group in which a continuous-pole coil is arranged in a range obtained by equally dividing the entire circumference by the number of magnetic poles/c, and the continuous-pole coils of the number of magnetic poles/c, which are adjacent to each other in the circumferential direction are sequentially and electrically connected to each other and wound, the continuous-pole coil in which b pieces of pole coils and a pole coil missing portion are adjacent to each other in no particular order, and the pole coils that are closest to each other in the circumferential direction are electrically connected, and the pole coil missing portion being made of blanks corresponding to (c-b) pieces of the pole coils, where the a laps are made in the same direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a partially enlarged cross-sectional view of a rotary electric machine;

FIG. 2 is a schematic diagram illustrating an example of a phase arrangement of 8 poles and 60 slots;

FIG. 3 is a schematic diagram illustrating a winding configuration of a first lap in a U-phase of 8 poles and 60 slots;

FIG. 4 is a schematic diagram illustrating a winding configuration of a second lap in the U-phase of 8 poles and 60 slots;

FIG. 5 is a schematic diagram illustrating a winding configuration of a third lap in the U-phase of 8 poles and 60 slots;

FIG. 6 is a schematic diagram illustrating an overall winding configuration of 8 poles and 60 slots;

FIG. 7 is a schematic diagram illustrating a unit coil of an adjacent pole coil connection portion on the outermost radial side;

FIG. 8 is a schematic diagram illustrating a unit coil of a pole coil;

FIG. 9 is a schematic diagram illustrating the unit coil of the adjacent pole coil connection portion on the innermost radial side;

FIG. 10 is a schematic diagram illustrating a unit coil of a continuous-pole coil connection portion;

FIG. 11 is a schematic diagram illustrating a winding configuration in a U-phase of 8 poles and 36 slots;

FIG. 12 is a schematic diagram illustrating a winding configuration in a U-phase of 8 poles and 30 slots;

FIG. 13 is a schematic diagram illustrating a winding configuration in a U-phase of 10 poles and 36 slots;

FIG. 14 is a schematic diagram illustrating a winding configuration in a U-phase of 10 poles and 42 slots;

FIG. 15 is a schematic diagram illustrating a winding configuration in a U-phase of 8 poles and 42 slots;

FIG. 16 is a schematic diagram illustrating a winding configuration in a U-phase of 8 poles and 18 slots;

FIG. 17 is a schematic diagram illustrating a winding configuration of a short-section pitch in the U-phase of 8 poles and 60 slots;

FIG. 18 is a schematic diagram illustrating a winding configuration of a long-section pitch in the U-phase of 8 poles and 60 slots;

FIG. 19 is a schematic diagram illustrating a modification example of a phase starting end position of FIG. 15; and

FIG. 20 is a schematic diagram illustrating another modification example of the phase starting end position of FIG. 15.

### DETAILED DESCRIPTION

Hereinafter, embodiments of a rotary electric machine according to this disclosure will be described with reference to the drawings. In this embodiment, a three-phase AC synchronous motor (referred to as a motor M below) will be described as an example of the rotary electric machine. The present disclosure is not limited to the following embodiments, and various modifications can be made without departing from the gist thereof.

Basic Configuration

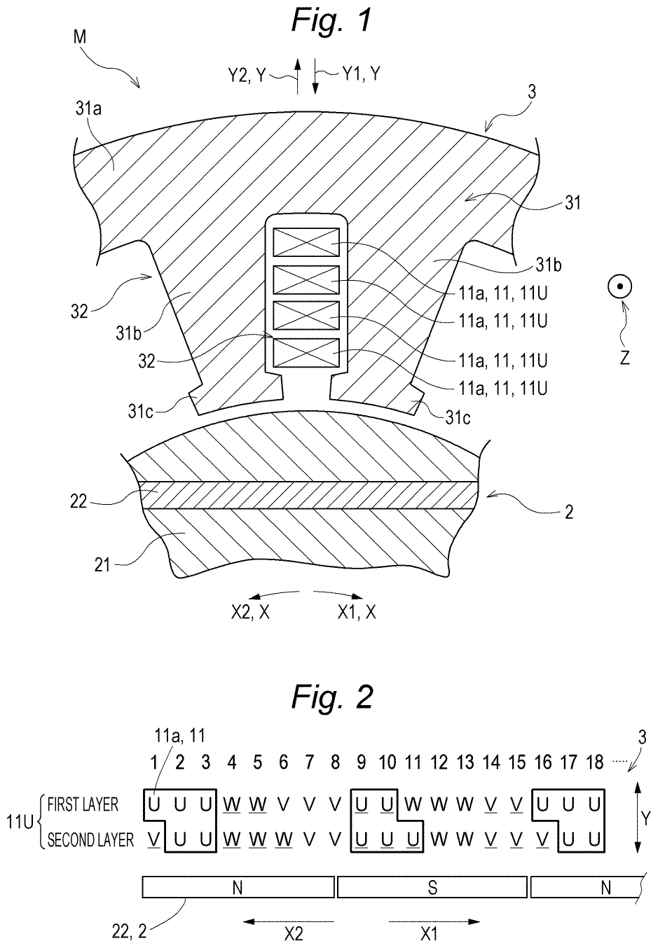

As illustrated in FIG. 1, the motor M includes a stator 3 and a rotor 2. The stator 3 has a plurality of slots 32 accommodating coil sides 11a of a plurality of unit coils (example of coils) 11 configured by segment conductors (referred to as a “winding” below). The rotor 2 faces the stator 3 and includes a plurality of permanent magnets (example of magnetic poles) 22. In the following description, a rotation direction or a reverse rotation direction of the rotor 2 is referred to as a circumferential direction X, a radial direction of the rotor 2 is referred to as a radial direction Y, and a direction parallel to a rotation shaft core of the rotor 2 is referred to as an axial direction (orthogonal direction) Z. In the circumferential direction X, a direction in which the rotor 2 rotates is referred to as a rotation direction X1, and the opposite direction is referred to as a reverse rotation direction X2. In the radial direction Y, a direction from the stator 3 to the rotor 2 (direction toward an opening of the slot 32) is referred to as a radially-inward direction Y1, and a direction from the rotor 2 to the stator 3 is referred to as a radially-outward direction Y2 (direction toward the bottom of the slot 32).

The stator 3 includes a tubular stator core 31. The stator core 31 is formed by stacking a plurality of magnetic steel plates. The stator core 31 includes a yoke portion 31a, a plurality of teeth portions 31b, and a flange portion 31c. The yoke portion is formed in an annular shape on the radially-outward direction Y2 side. The teeth portion protrudes from the yoke portion 31a in the radially-inward direction Y1. The flange portion 31c is arranged at protruding ends of each of the plurality of teeth portions 31b in the circumferential direction X. The slot 32 that accommodates the coil side 11a of the unit coil 11 configured by windings is formed between the teeth portions 31b adjacent to each other. The plurality of slots 32 of which the number is equal to the number of the plurality of teeth portions 31b are provided.

The rotor 2 includes a tubular rotor core 21 formed by stacking a plurality of magnetic steel plates, and a plurality of permanent magnets 22 buried in the rotor core 21. The rotor core 21 is supported by a shaft member (not illustrated) and is configured so that the rotor 2 is rotatable relative to the stator 3 in the rotation direction X1 and the reverse rotation direction X2. The permanent magnet 22 is configured of a rare earth magnet or the like, and N poles and S poles are alternately arranged in the circumferential direction X. The outer circumferential surfaces of the plurality of permanent magnets 22 may be exposed from the rotor core 21.

In this embodiment, the motor M is configured by fractional slots in which a value (referred to as the number of slots per pole and phase or Nspp below) obtained by dividing the number of slots 32 of the stator 3 by the number of phases (three phases in this embodiment) and the number of magnetic poles of the rotor 2 is more than ½, and the denominator is equal to or more than 2 when the number of slots per pole and phase is expressed by an irreducible fraction. The number of slots per pole and phase is expressed below as a+b/c in a mixed irreducible fraction expression (a indicates an integer portion, b/c indicates the irreducible fraction portion and satisfies b<c, where a is zero or a positive integer, and b and c are positive integers). For example, in a motor M of 8 poles and 60 slots, the number of slots per pole and phase is 5/2 (a=2, b=1, c=2).

The winding wound around the plurality of slots 32 is configured by, for example, a segment conductor in which a copper wire is coated with an insulating layer. For this winding, a square wire having a rectangular cross section, a round wire having a circular cross section, and various conductive wires having a polygonal cross section are used. In this embodiment, a winding method of the winding around the slots 32 is configured by lap winding.

As illustrated in FIG. 1, in each of the coils of phases (U-phase, V-phase, and W-phase), a plurality of unit coils 11 are stacked in the slot 32 in the radial direction Y. The fractional slot includes a plurality of sets of two-layer units 11U configured by coil sides 11a of unit coils 11 having two layers in which two unit coils 11 are stacked (for example, four sets in which one layer to two layers in FIG. 2 are repeated in the radial direction Y). In this embodiment, regarding the coil of each phase in this embodiment, a plurality of unit coils 11 are stacked in the radial direction Y to form a plurality of layers and then are accommodated in the slot 32. The three-phase coils are electrically connected by Y connection. The three-phase coils may be electrically connected by A connection, and the connection is not particularly limited. The “layers” having the same number are connected in the rotation direction X1 of the rotor 2 at the same position in a depth direction of the slot 32 (radial direction Y).

In the case of lap winding in a fractional slot, the coil pitch is preferably the closest integer to the number of slots per pole, which is obtained by dividing the number of slots 32 of the stator 3 by the number of magnetic poles of the rotor 2. For example, in the case of a motor M of 8 poles and 60 slots (the number of slots per pole is 7.5), the coil pitch is 7 slots (short-section winding) as a short-section pitch or 8 slots (long winding) as a long-section pitch.

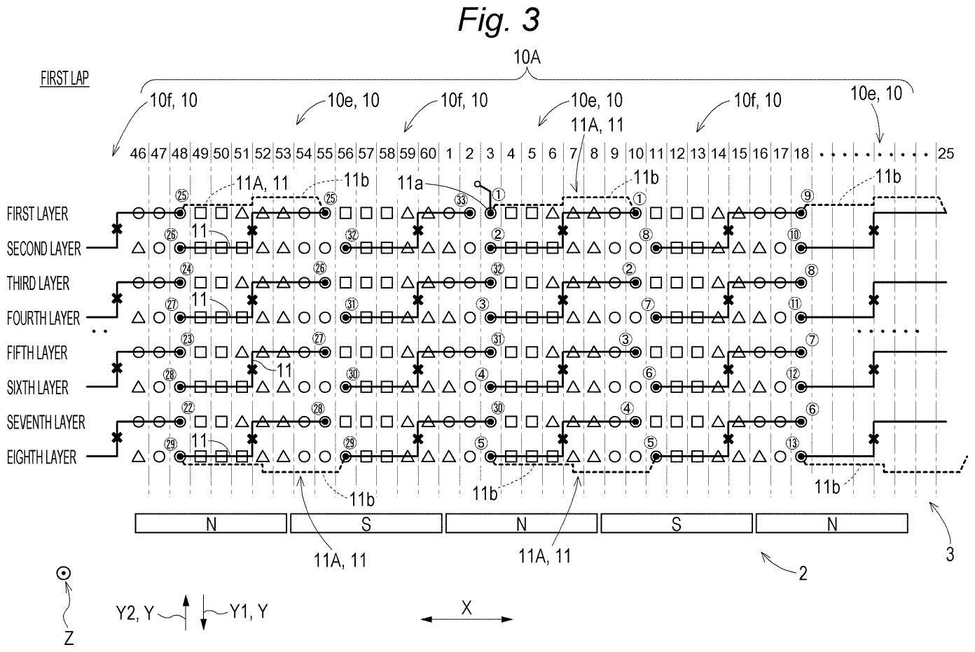

FIG. 2 illustrates an example of a magnetic-pole facing state between the phase arrangement of the coil sides 11a of windings wound around a plurality of slots 32 and magnetic poles (N pole and S pole) of a pair of rotors 2, according to this embodiment. FIG. 2 illustrates FIG. 1 in a straight line for convenience (the inner radial side is expanded for convenience). Illustrations of the yoke portion 31a, the teeth portion 31b, and the windings are omitted. Serial numbers described on the upper part of FIG. 2 indicate the slot numbers of the slots 32. The U-phase coil, the V-phase coil, and the W-phase coil are shifted from each other by the phase of 120° as an electrical angle in the rotation direction X1 in this order. Since each phase (U phase, V phase, W phase) has the same phase arrangement except for the phase shift, the U-phase coil will be described below as a representative. In FIG. 2, the notation of “U” and the notation of “U” underlined indicate that the current directions are opposite to each other. The same notation indicates that the coil side 11a has the same current direction. Layers are expressed as a first layer, a second layer, and so on in order from the coil side 11a located in the most radially-outward direction Y2 in the radial direction Y to the coil side 11a in the radially-inward direction Y1. That is, as the layer-phase band arrangement of the slot 32 in the radial direction Y, the bottom layer of the slot 32 is set to 1, and the layers are counted in ascending order toward the opening portion of the slot 32 (the same is applied below). At this time, the even-numbered layer of the slot 32 is configured by moving an odd-numbered layer of the slot 32 in the circumferential direction X by a predetermined slot number (here, 7 or 8) configured by an integer closest to the number of slots per pole, which is obtained by multiplying the number Nspp of slots per pole and phase by the number (3) of phases. Here, when c=2, the movement direction of the even-numbered layer by the predetermined slot number with respect to the odd-numbered layer is either the rotation direction X1 or the reverse rotation direction X2. The layer-phase band arrangement of even-numbered layers or the layer-phase band arrangement of the odd-numbered layers has the same configuration in the circumferential direction X (see FIGS. 3 to 6 described later).

In this embodiment, in the case of a motor M of 8 poles and 60 slots, a fist phase band group and a second phase band group are alternately arranged in the circumferential direction X (see FIG. 2, but FIG. 2 illustrates only a first layer and a second layer). The first phase band group includes four sets of two-layer units 11U (from a first layer to an eighth layer) configured by coil sides 11a of a two-layer unit coil 11 in which three coil sides 11a for the first layer and two coil sides 11a for the second layer are stacked. The second phase band group includes four sets of two-layer units 11U (from a first layer to an eighth layer) configured by coil sides 11a of a two-layer unit coil 11 in which two coil sides 11a for the first layer and three coil sides 11a for the second layer are stacked.

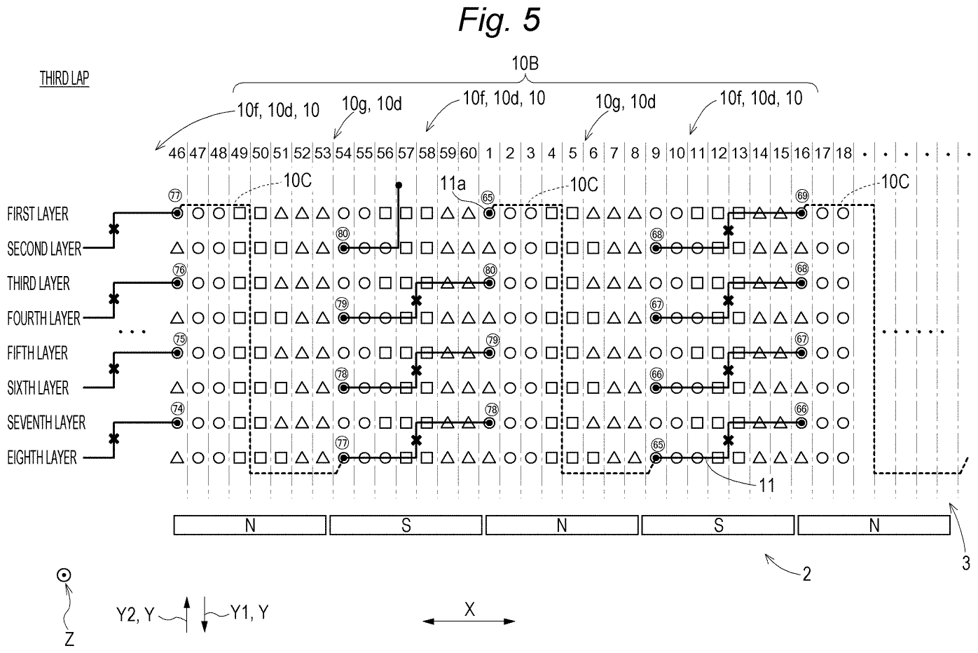

FIGS. 3 to 6 illustrate lap winding of the U phase, as an example of the winding method for the winding around the slot 32 in the case of a motor M of 8 poles and 60 slots (Nspp=2.5, a=2, b=1, c=2). Here, FIGS. 3 to 6 illustrate a case in which the coil side 11a made of one segment conductor is accommodated in one layer, eight coil sides 11a are accommodated in one slot, and all in-phase unit coils are connected in a series, and thus the number of series turns of one phase is 80. The numbers in the upper part in FIGS. 3 to 6 indicate the slot numbers. The circled numbers in FIGS. 3 to 6 indicate the winding order of each turn. The white circle (see FIG. 3) in FIGS. 3 to 6 connected to the turn having the winding order No. 1 indicates a winding starting end. The black circle (see FIG. 5) in FIGS. 3 to 6 connected to the turn having the winding order No. 80 indicates a winding termination. The x mark in FIGS. 3 to 6 indicates a unit coil connection portion in which a pair of unit coils 11 are electrically connected by welding or the like. ∘ indicates the coil side 11a of the U phase, Δ indicates the coil side 11a of the V phase, and □ indicates the coil side 11a of the W phase. Each of ∘, Δ, and □ is arranged in eight layers for each slot number. The solid line indicates the coil end arranged on the upper surface (front side of the paper surface) of the stator 3. The broken line indicates the coil end arranged on the lower surface (back side of the paper surface) of the stator 3. One turn formed by two coil sides 11a having the same circled number in FIGS. 3 to 6 is defined below as one unit coil 11. An assembly of a plurality of unit coils 11 facing one magnetic pole of the rotor 2 is defined below as one pole coil 10.

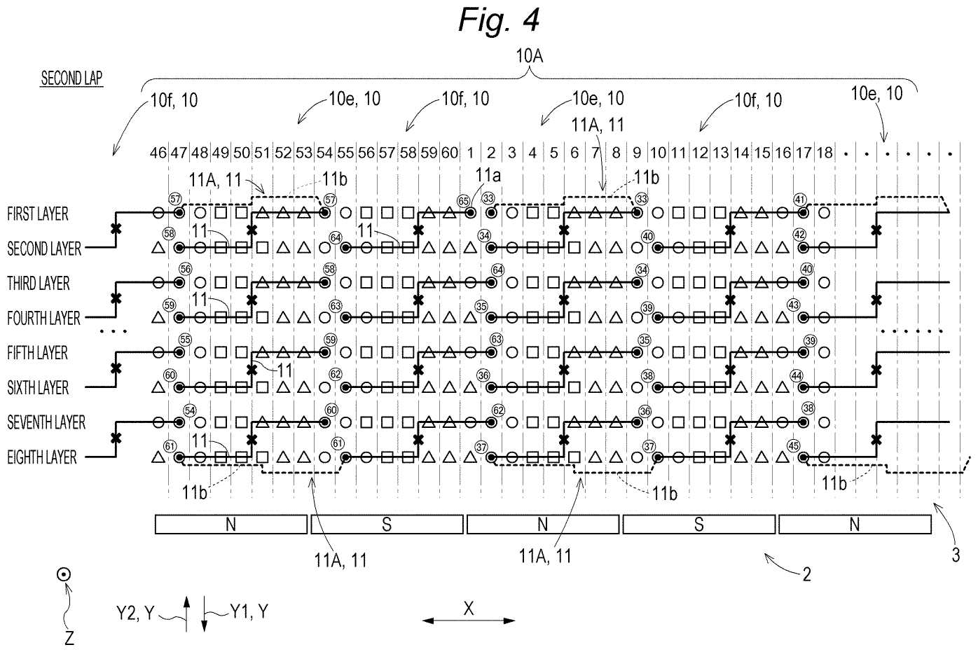

As illustrated in FIGS. 3 to 4, the coil for a laps (first lap or second lap illustrated in FIGS. 3 and 4 because a=2) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. Here, lap directions for the a laps are the same as each other. As illustrated in FIG. 5, the coil of a (a+1)th lap ((a+1)=3, third lap) includes a continuous-pole coil group 10B in which continuous-pole coils 10d of which the number is the number of magnetic poles (8 poles)/c pieces (4 pieces because c=2) are arranged in the circumferential direction X. The continuous-pole coil 10d includes b pieces (b=1) of pole coils 10 that face c pieces (c=2) of magnetic poles and are electrically connected. The continuous-pole coils 10d adjacent to each other in the circumferential direction X are electrically connected by a continuous-pole coil connection portion 10C (pole coil connection portion that sequentially and electrically connects pole coils 10 between the continuous-pole coils 10d). In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (4 equal parts because c=2), and the continuous-pole coils 10d of the number of magnetic poles/c pieces (4 pieces because c=2), which are adjacent to each other in the circumferential direction X are sequentially and electrically connected to each other and wound. In the continuous-pole coil, b pieces (b=1) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c-b) pieces (c-b=1) of the pole coils 10. Here, the continuous-pole coil 10d electrically and sequentially connects the closest pole coils 10 adjacent to each other in the circumferential direction X when two or more pole coils 10 are provided. The continuous-pole coil group 10B is configured in a manner that the continuous-pole coils 10d of the number of magnetic poles/c pieces (4 pieces because c=2) are arranged at equal pitches in the circumferential direction X, and the continuous-pole coils 10d are electrically connected by the continuous-pole coil connection portion 10C. As described above, the adjacent pole coil group 10A for the a laps and the continuous-pole coil group 10B for the (a+1) laps are connected in series to form a phase coil.

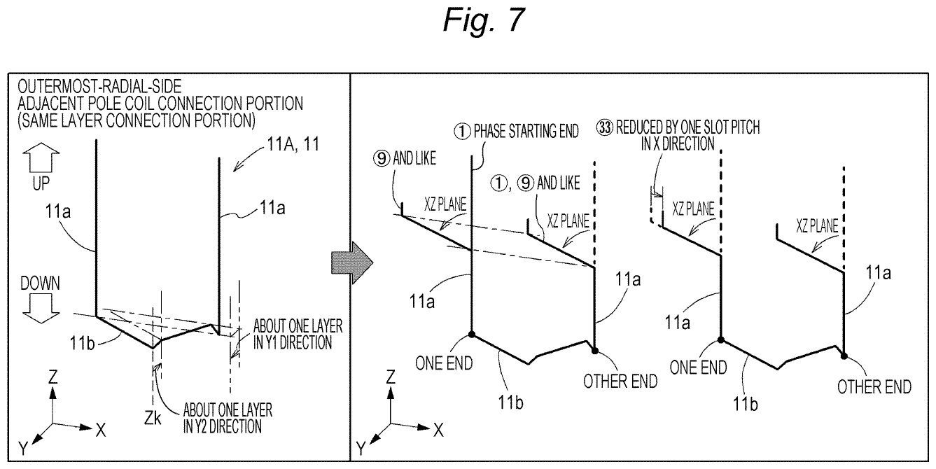

As illustrated in FIGS. 7 to 10, the unit coil 11 configured by segment conductors includes a pair of coil sides 11a accommodated in two slots 32, and one turn coil end 11b that electrically connects the pair of coil sides 11a. In this embodiment, the turn coil end 11b means a coil end required to form one turn by electrically connecting the coil sides 11a that have the same winding order (referred to as a “turn order” below, and there are 1 to 80 turns in each phase) indicated by the circled numbers in FIGS. 3 to 5. The unit coil connection portion indicated by the x marks in FIGS. 3 to 5 means a coil end (coil end for connection between one turn) that electrically connects the coil sides 11a having turn orders that are shifted from each other by 1. For easy description, the unit coil connection portion is not included in the turn coil end 11b.

As illustrated in FIGS. 3 to 4, in the adjacent pole coil group 10A constituting the coil for the a laps, a first pole coil 10e and a second pole coil 10f are alternately arranged adjacent to the circumferential direction X. The first pole coil 10e includes the turn coil end 11b connecting the same layers in the radial direction Y of the slots 32. The second pole coil 10f that does not include the turn coil end 11b connecting the same layers in the radial direction Y of the slots 32. In FIGS. 3 to 5, the turn coil end 11b connecting different layers that are shifted by one layer and are arranged on the lower surface (back side of the paper surface) of the stator 3 is not illustrated.

That is, in the adjacent pole coil group 10A, the first pole coils 10e including the turn coil end 11b connecting the same layers in the radial direction Y of the slots 32 are arranged at each pole separated by one pole, and the second pole coils 10f that do not include the turn coil end 11b connecting the same layers in the radial direction Y of the slots 32 are arranged at each pole separated by one pole. Here, the “first pole coil 10e including the turn coil end 11b connecting the same layers in the radial direction Y of the slots 32” refers to the pole coil 10 including the coil end (turn coil end 11b) connecting the coil sides 11a that are arranged in the first layer (or eighth layer) and have the same phase with each other in the same layer, as illustrated in FIG. 3.

In the adjacent pole coil connection portion 11A configured by the unit coil 11 including the turn coil end 11b connecting the same layers in the radial direction Y of the slots 32, the turn coil end 11b is arranged on the outermost radial side being the most radially-outward direction Y2 of the slot 32 and on the innermost radial side being the most radially-inward direction Y1.

As illustrated in FIG. 5, the continuous-pole coil group 10B for a (a+1)th lap ((a+1)=3, third lap) is configured only by the second pole coil 10f that does not include the turn coil end 11b connecting the same layers in the radial direction Y of the slots 32 when the number of blanks between the pole coils 10 is all odd (1). The continuous-pole coil connection portion 100 electrically connects the continuous-pole coils 10d of the number of magnetic poles (8 poles)/c pieces (4 because c=2) with each other. When the number of blanks is odd (1), the continuous-pole coil connection portion 100 across the blanks electrically connects the first layer of the slot 32 on the outermost radial side being the most radially-outward direction Y2 of the slot 32 and the eighth layer on the innermost radial side being the most radially-inward direction Y1.

In summary, the phase coil configuration in this embodiment is obtained in a manner as follows. A configuration in which the pole coils 10 adjacent to each other in the circumferential direction X are electrically connected by the adjacent pole coil connection portion 11A is rotated a times in the rotation direction X1. Then, one lap is made in the rotation direction X1 with the continuous-pole coil group 10B in which the b pieces of pole coils 10 and the pole coil missing portion 10g made of blanks corresponding to (c-b) pieces (c-b=1) of the pole coils 10 are adjacent to each other in no particular order, for each of c continuous-poles, and the continuous-pole coils 10d of the number of magnetic poles/c arranged in the circumferential direction X that electrically connect the pole coils 10 that are closest to each other in the circumferential direction X are sequentially and electrically connected by the continuous-pole coil connection portion 10C. With this configuration, the adjacent pole coil group 10A or the continuous-pole coil group 10B for the second lap and subsequent laps is shifted from the adjacent pole coil group 10A for the previous lap, in a direction (reverse rotation direction X2) opposite to an a-lap direction (rotation direction X1) by one slot pitch. For example, as illustrated in FIGS. 3 to 4, the 38th turn (coil-side-arrangement slots 10 and 17) is shifted from the sixth turn (same arrangement slots 11 and 18) by one slot pitch in a direction opposite to the a lap direction. As illustrated in FIGS. 4 to 5, the 66th turn (same arrangement slots 9 and 16) is shifted from the 38th turn by one slot pitch in the direction opposite to the a-lap direction.

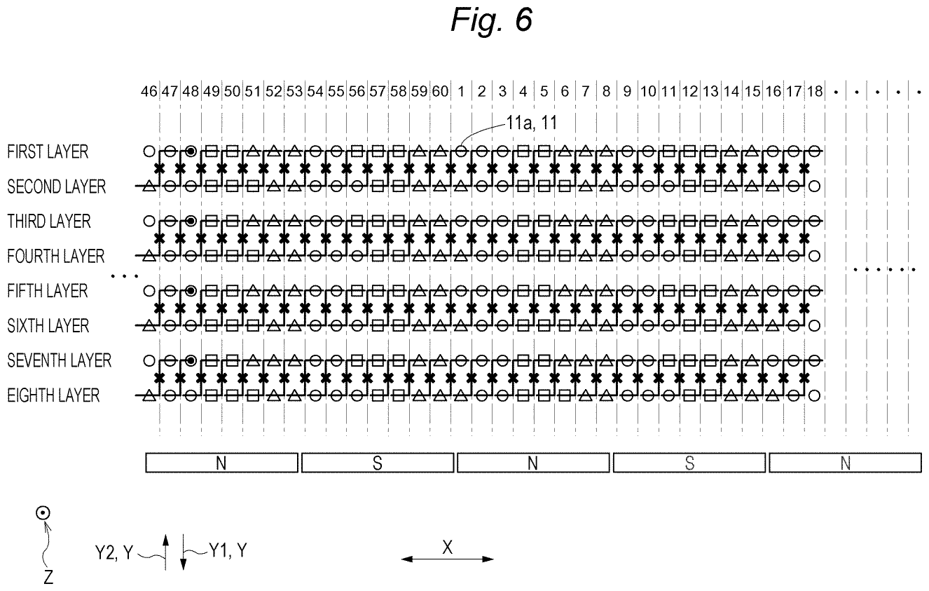

FIG. 6 illustrates a schematic plan view (illustrating the coil end arranged on the upper end surface (front side of the paper surface) of the stator core 31) without illustrations of the adjacent pole coil connection portion 11A and the continuous-pole coil connection portion 100 arranged on the lower end surface (back side of the paper surface) of the stator core 31 when the coil of three phases being the U phase, the V phase, and the W phase is wound around the slot 32 based on the above regulations. As can be seen from FIG. 6, it is possible to visually recognize that the unit coil connection portion in which the pair of unit coils 11 are electrically connected by welding or the like can be arranged evenly without being interfered by another coil and another connection portion between coil turns (unit coil connection portion). Thus, after all the coil sides 11a of the unit coils 11 configured by segment conductors of the three phases being the U phase, the V phase, and the W phase are inserted into the slot 32, the coil turn connection portion (unit coil connection portion) is bent. Thus, the work of connecting the pair of unit coils 11 by welding or the like becomes very easy. When a 2, in each phase, a connecting portion to the next lap is reduced by one slot pitch by another equivalent connection portion between adjacent pole coils. This is because the pole coils 10 for the second and subsequent laps are shifted from the previous pole coil by one slot pitch in the circumferential direction X being a direction opposite to the a-lap direction. Thus, at this location, the bending position and the like that cause the connection portion between coil turns or a neutral-point extraction portion to have an arrangement relation equivalent to others are adjusted.

FIGS. 7 to 10 illustrate the unit coil 11 for the adjacent pole coil connection portion 11A on the outermost radial side, the unit coil 11 of the pole coil 10 not for the adjacent pole coil connection portion 11A, the unit coil 11 for the adjacent pole coil connection portion 11A on the innermost radial side, and the unit coil 11 for the continuous-pole coil connection portion 100. As illustrated in FIGS. 3 to 5, the total of 80 unit coils 11 that are 8 unit coils 11 for the adjacent pole coil connection portion 11A on the outermost radial side, 60 unit coils 11 of the pole coils 10 not for the adjacent pole coil connection portion 11A, 8 unit coils 11 for the adjacent pole coil connection portion 11A on the innermost radial side, and 4 unit coils 11 for the continuous-pole coil connection portion 10C are used for the U phase of a motor M of 8 poles and 60 slots. The winding configuration using the unit coil 11 will be described below with reference to FIGS. 3 to 10. The slot numbers illustrated in the upper part of FIGS. 3 to 6 are referred to as a first slot to a 60th slot. Description will be made on the assumption that the side of the turn coil end 11b illustrated in FIGS. 7 to 10 is set to be the bottom (back side of the paper surface in the Z direction illustrated in FIG. 3), and the opposite side (front side of the paper surface in the Z direction illustrated in FIG. 3) is set to be the top. In FIGS. 3 to 6, the solid line indicates the coil end arranged on the upper surface of the stator 3, and the broken line indicates the coil end arranged on the lower surface of the stator 3. In FIGS. 3 to 6, the illustration of the turn coil end 11b other than the turn coil end 11b that is arranged on the lower surface of the stator 3 and connects the same layers and the turn coil end 11b constituting the continuous-pole coil connection portion 100.

As illustrated in the left view of FIG. 7, in the unit coil 11 for the adjacent pole coil connection portion 11A on the outermost radial side, a pair of linear coil sides 11a are connected to both ends of the turn coil end 11b configured with the short-section pitch. The turn coil end 11b is bent in in the radially-outward direction Y2 at the central portion (reference position Zk) extending from one end by a slot pitch of the short-section pitch/2, and is bent in the radially-inward direction Y1 at the other end extending from the central portion.

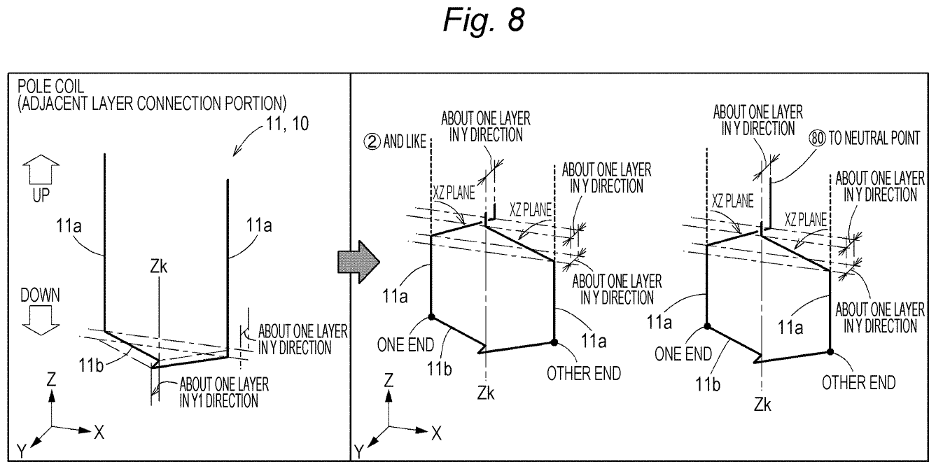

As illustrated in the left view of FIG. 8, in the unit coil 11 of the pole coil 10 not for the adjacent pole coil connection portion 11A, a pair of linear coil sides 11a are connected to both ends of the turn coil end 11b configured with the short-section pitch. The turn coil end 11b is bent in in the radially-inward direction Y1 at the central portion (reference position Zk) extending from one end by a slot pitch of the short-section pitch/2.

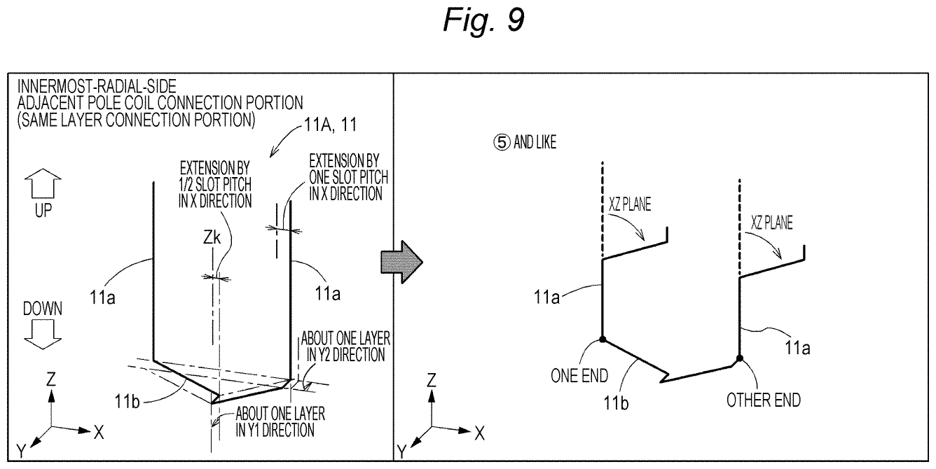

As illustrated in the left view of FIG. 9, in the unit coil 11 for the adjacent pole coil connection portion 11A on the innermost radial side, a pair of linear coil sides 11a are connected to both ends of the turn coil end 11b configured with the long-section pitch. The turn coil end 11b is bent in in the radially-inward direction Y1 at the central portion extending from one end by a slot pitch of the long-section pitch/2, and is bent in the radially-outward direction Y2 at the other end extending from the central portion. The turn coil end 11b configured with the long-section pitch extends the central portion (reference position Zk) of the above-described turn coil end 11b configured with the short-section pitch, in the circumferential direction X by ½ slot pitch, and extends the other end of the turn coil end 11b in the circumferential direction X by one slot pitch.

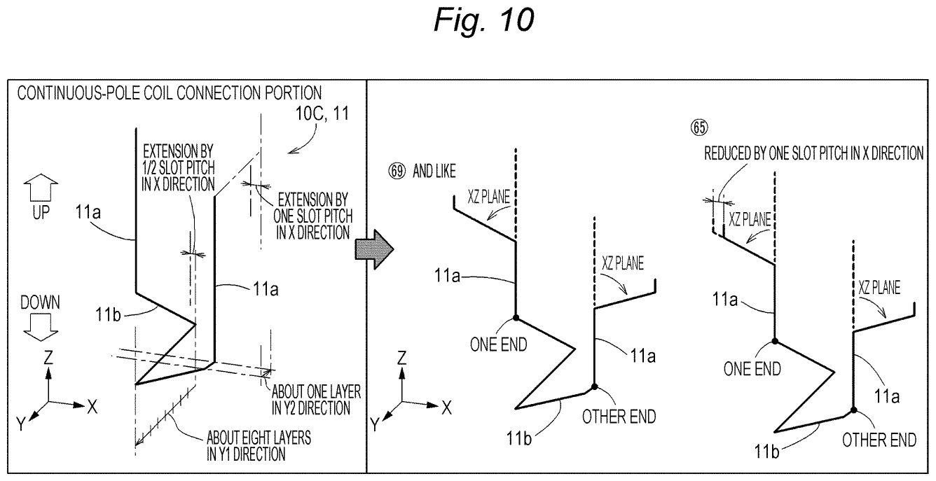

As illustrated in the left view of FIG. 10, in the unit coil 11 for the continuous-pole coil connection portion 100, a pair of linear coil sides 11a are connected to both ends of the turn coil end 11b configured with the long-section pitch. The turn coil end 11b is bent in in the radially-inward direction Y1 at the central portion extending from one end by a slot pitch of the long-section pitch/2, and is bent in the radially-outward direction Y2 at the other end extending from the central portion. The turn coil end 11b configured with the long-section pitch extends the central portion (reference position Zk) of the above-described turn coil end 11b configured with the short-section pitch, in the circumferential direction X by ½ slot pitch, and extends the other end of the turn coil end 11b in the circumferential direction X by one slot pitch.

Then, the turn order using the unit coil 11 described above will be described. As illustrated in FIGS. 3 and 7, in a first turn as the start turn of the first lap, in the unit coil 11 for the adjacent pole coil connection portion 11A on the outermost radial side, the coil side 11a is inserted into the first layer of the third slot and the first layer of the 10th slot so that the turn coil end 11b being one coil end is arranged below the stator 3. As illustrated in the central view of FIG. 7, the other coil end is formed by inward bending a linear winding including the coil side 11a connected to the other end of the turn coil end 11b. The tip of the linear winding including the coil side 11a connected to one end of the turn coil end 11b may be electrically connected to the phase starting end or may constitute the phase starting end. In this embodiment, the phase starting end of the coil is pulled out from the slot 32 (third slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (3) of the integers (2 and 3) closest to Nspp (2.5). The phase band including the slot 32 for pulling out the phase starting end is a phase band (for example, first, second, and third slots in which the number of continuous slots is 3) in which the number of odd-numbered (first) continuous slots at the shortest distance in the circumferential direction X is relatively large with respect to a phase band (for example, 54th and 55th slots in which the number of continuous slots is 2) in which the number of continuous slots constituting a layer-phase band at the bottom (first layer) of the slot 32 is relatively small.

As illustrated in FIGS. 3 and 8, in a second turn, in the unit coil 11 of the pole coil 10, the coil side 11a is inserted into the second layer of the third slot and the third layer of the 10th slot so that the turn coil end 11b being one coil end is arranged below the stator 3. As illustrated in the central view of FIG. 8, the other coil end is formed in a manner that a linear winding including the coil side 11a connected to one end of the turn coil end 11b is bent inward of the turn, and a linear winding including the coil side 11a connected to the other end of the turn coil end 11b is bent inward of the turn. The coil end located on one end side of the turn coil end 11b of the second turn is connected to the coil end located on the other end side of the turn coil end 11b of the first turn by welding or the like.

As illustrated in FIGS. 3 and 8, in a third turn, in the unit coil 11 of the pole coil 10, the coil side 11a is inserted into the fourth layer of the third slot and the fifth layer of the 10th slot so that the turn coil end 11b being one coil end is arranged below the stator 3. As illustrated in the central view of FIG. 8, the other coil end is formed in a manner that a linear winding including the coil side 11a connected to one end of the turn coil end 11b is bent inward of the turn, and a linear winding including the coil side 11a connected to the other end of the turn coil end 11b is bent inward of the turn. The coil end located on one end side of the turn coil end 11b of the third turn is connected to the coil end located on the other end side of the turn coil end 11b of the second turn by welding or the like.

After a fourth turn is made in a manner similar to the third turn, as illustrated in FIGS. 3 and 9, in a fifth turn, in the unit coil 11 for the adjacent pole coil connection portion 11A on the innermost radial side, the coil side 11a is inserted into the eighth layer of the third slot and the eighth layer of the 10th slot so that the turn coil end 11b being one coil end is arranged below the stator 3. As illustrated in the central view of FIG. 9, the other coil end is formed in a manner that a linear winding including the coil side 11a connected to one end of the turn coil end 11b is bent inward of the turn, and a linear winding including the coil side 11a connected to the other end of the turn coil end 11b is bent outward of the turn. The coil end located on one end side of the turn coil end 11b of the fifth turn is connected to the coil end located on the other end side of the turn coil end 11b of the fourth turn by welding or the like. The coil end located on the other end side of the turn coil end 11b of the fifth turn is connected to the coil end located on one end side of the turn coil end 11b of a sixth turn by welding or the like. In this manner, the first pole coil 10e configured in the turn order from the first turn to the fifth turn is formed.

Since turns of the sixth turn to an eighth turn are made by repetition in a similar manner to that for the turns of the second turn to the fourth turn, description thereof will not be repeated.

As illustrated in FIGS. 3 and 7, in a ninth turn, in the unit coil 11 for the adjacent pole coil connection portion 11A on the outermost radial side, the coil side 11a is inserted into the first layer of the 18th slot and the first layer of the 25th slot so that the turn coil end 11b being one coil end is arranged below the stator 3. As illustrated in the central view of FIG. 7, the other coil end is formed in a manner that a linear winding including the coil side 11a connected to one end of the turn coil end 11b is bent outward of the turn, and a linear winding including the coil side 11a connected to the other end of the turn coil end 11b is bent inward of the turn. The coil end located on one end side of the turn coil end 11b of the ninth turn is connected to the coil end located on the other end side of the turn coil end 11b of the eighth turn by welding or the like. The coil end located on the other end side of the turn coil end 11b of the ninth turn is connected to the coil end located on one end side of the turn coil end 11b of a tenth turn by welding or the like. Similarly, since turns of the tenth turn to a 16th turn are made by repetition in a similar manner to that for the turns of the second turn to the eighth turn, description thereof will not be repeated.

The first lap is completed by repeating the repetition from the ninth turn to the 16th turn, from a 17th turn to a 24th turn and from a 25th turn to a 32nd turn.

As illustrated in FIGS. 4 and 7, in a 33rd turn as the start turn of a second lap, in the unit coil 11 for the adjacent pole coil connection portion 11A on the outermost radial side, the coil side 11a is inserted into the first layer of the second slot and the first layer of the ninth slot so that the turn coil end 11b being one coil end is arranged below the stator 3. As illustrated in the right view of FIG. 7, the other coil end is formed in a manner that a linear winding including the coil side 11a connected to one end of the turn coil end 11b is bent outward of the turn, and a linear winding including the coil side 11a connected to the other end of the turn coil end 11b is bent inward of the turn. At this time, since the 33rd turn is the unit coil 11 that connects the first lap and the second lap which is shifted from the first lap by one slot pitch in the direction opposite to the a-lap direction, the coil end located on one end side of the turn coil end 11b is reduced by one slot pitch in the circumferential direction X. The coil end located on one end side of the turn coil end 11b of the 33rd turn is connected to the coil end located on the other end side of the turn coil end 11b of the 32nd turn by welding or the like. The coil end located on the other end side of the turn coil end 11b of the 33rd turn is connected to the coil end located on one end side of the turn coil end 11b of a 34th turn by welding or the like. In the 33rd turn, the coil end located on the one end side of the turn coil end 11b is reduced by one slot pitch in the circumferential direction X by one slot pitch, but the slot pitch of the turn coil end 11b of the adjacent pole coil connection portion 11A is not changed in the short-section pitch. Thus, it is sufficient to, for example, cut the end portion of the unit coil 11, and it is possible to share the unit coil 11.

The second lap is completed by repeating turns of the 34th turn to a 64th turn are made by repetition in a similar manner to that for the turns of the second turn to the 32nd turn.

As illustrated in FIGS. 5 and 10, in a 65th turn as the start turn of a third lap, in the unit coil 11 for the continuous-pole coil connection portion 100, the coil side 11 a is inserted into the first layer of the first slot and the eighth layer of the ninth slot so that the turn coil end 11b being one coil end is arranged below the stator 3. As illustrated in the right view of FIG. 10, the other coil end is formed in a manner that a linear winding including the coil side 11a connected to one end of the turn coil end 11b is bent outward of the turn, and a linear winding including the coil side 11a connected to the other end of the turn coil end 11b is bent outward of the turn. At this time, since the 65th turn is the unit coil 11 that connects the second lap and the third lap which is shifted from the second lap by one slot pitch in the direction opposite to the a-lap direction, the coil end located on one end side of the turn coil end 11b is reduced by one slot pitch in the circumferential direction X, in comparison to the unit coil 11 for another continuous-pole coil connection portion 100. The coil end located on one end side of the turn coil end 11b of the 65th turn is connected to the coil end located on the other end side of the turn coil end 11b of the 64th turn by welding or the like. The coil end located on the other end side of the turn coil end 11b of the 65th turn is connected to the coil end located on one end side of the turn coil end 11b of a 66th turn by welding or the like. In the 65th turn, the coil end located on the one end side of the turn coil end 11b is reduced by one slot pitch in the circumferential direction X, but the slot pitch of the turn coil end 11b of the continuous-pole coil connection portion 10C is not changed in the long-section pitch. Thus, it is sufficient to, for example, cut the end portion of the unit coil 11, and it is possible to share the unit coil 11.

Since turns of the 66th turn to a 68th turn are made by repetition in a similar manner to that for the above-described turns of the second turn to the fourth turn, description thereof will not be repeated.

As illustrated in FIGS. 5 and 10, in a 69th turn, in the unit coil 11 for the continuous-pole coil connection portion 100, the coil side 11a is inserted into the first layer of the 16th slot and the eighth layer of the 24th slot so that the turn coil end 11b being one coil end is arranged below the stator 3. As illustrated in the central view of FIG. 10, the other coil end is formed in a manner that a linear winding including the coil side 11a connected to one end of the turn coil end 11b is bent outward of the turn, and a linear winding including the coil side 11a connected to the other end of the turn coil end 11b is bent outward of the turn. The coil end located on one end side of the turn coil end 11b of the 69th turn is connected to the coil end located on the other end side of the turn coil end 11b of a 68th turn by welding or the like. The coil end located on the other end side of the turn coil end 11b of the 69th turn is connected to the coil end located on one end side of the turn coil end 11b of a 70th turn by welding or the like. Similarly, since turns of the 70th turn to a 73rd turn and turns of a 74th turn to a 77th turn are made by repetition in a similar manner to that for the turns of the 66th turn to the 69th turn, description thereof will not be repeated.

Since turns of a 78th turn to a 79th turn are made in a similar manner to that for the turns of the 66th turn to the 67th turn, description thereof will not be repeated. Finally, in an 80th turn, as illustrated in FIGS. 5 and 8, in the unit coil 11 of the pole coil 10, the coil side 11a is inserted into the second layer of the 54th slot and the third layer of the first slot so that the turn coil end 11b being one coil end is arranged below the stator 3. As illustrated in the right view of FIG. 8, the other coil end is formed in a manner that a linear winding including the coil side 11a connected to one end of the turn coil end 11b is bent inward of the turn, and a linear winding including the coil side 11a connected to the other end of the turn coil end 11b is bent inward of the turn. The coil end located on one end side of the turn coil end 11b of the 80th turn is connected to the coil end located on the other end side of the turn coil end 11b of the 79th turn by welding or the like. The tip of the linear winding including the coil side 11a connected to one end of the turn coil end 11b in the 80th turn is electrically connected to the neutral point as the phase termination.

In a manufacturing method of the winding configuration of the motor M, the unit coil 11 for the adjacent pole coil connection portion 11A on the outermost radial side illustrated in FIG. 7, the unit coil 11 of the pole coil 10 illustrated in FIG. 8, the unit coil 11 for the adjacent pole coil connection portion 11A on the innermost radial side illustrated in FIG. 9, and the unit coil 11 for the continuous-pole coil connection portion 10C illustrated in FIG. 10 are arranged below the stator 3, as a coil group arranged in the above-described turn order, and the coil sides 11a of the unit coils 11 are collectively inserted into the slots 32. Then, a unit coil connection portion in which the coil ends of a pair of unit coils 11 are electrically connected by welding or the like is produced by bending a linear winding including the coil side 11a of the unit coil 11 inserted into the slot 32 except for the linear winding including the coil side 11a connected to one end of the turn coil end 11b for one turn. A linear winding including the coil side 11a connected to one end of the turn coil end 11b in the first turn of the U phase, the V phase, and the W phase is electrically connected to the phase starting end of each phase, or the phase starting end is directly formed on the linear winding. Then, linear windings including the coil side 11a connected to one end of the turn coil end 11b in the 80th turn of the U phase, the V phase, and the W phase are electrically connected to each other to form the neutral point. As a result, the motor M in which the three-phase coils are electrically connected by Y connection is completed.

As described above, in the pole coil 10, in the unit coil 11 for eight adjacent pole coil connection portions 11A on the outermost radial side illustrated in FIG. 7, the slot pitch of the turn coil end 11b is configured as the short-section pitch, and 60 unit coils 11 illustrated in FIG. 8 are configured with the short-section pitch in which the turn coil end 11b other than the same layer connection portion is inclined or bent by one layer from the outer radial side to the inner radial side (Y1 direction) in the a-lap direction. The unit coil 11 for eight adjacent pole coil connection portions 11A on the innermost radial side illustrated in FIG. 9 and the unit coil 11 of four continuous-pole coil connection portions 100 illustrated in FIG. 10 are configured with the long-section pitch as the slot pitch of the turn coil end 11b. As described above, 68 unit coils 11 have the turn coil end 11b of the short-section pitch, and 12 unit coils 11 have the turn coil end 11b of the long-section pitch. Thus, most of the unit coils are configured by the unit coils 11 of the short-section pitch, and the total coil length of the motor M is shorter than that of wave winding. As described above, in the motor M in this embodiment, it is possible to reduce the total coil length and reduce the manufacturing cost.

Although not illustrated in FIG. 6, the coil end for the adjacent pole coil connection portion 11A illustrated in FIGS. 7 and 9 is bent in the Y direction by about one layer so as to be arranged on the outermost radial side or the innermost radial side. Therefore, there is no interference with the turn coil end 11b of the unit coil 11. Since the coil end except for the lower surface crossing portion of the stator 3 in the Y direction among the coil ends of the continuous-pole coil connection portion 100 illustrated in FIG. 10 is bent in the Y direction by about one layer so as to be arranged on the outermost radial side or the innermost radial side, there is no interference with the turn coil end 11b of the unit coil 11. The adjacent pole coil connection portions 11A of the U-phase, the V-phase, and the W-phase do not interfere with the continuous-pole coil connection portions 100 of the U-phase, the V-phase, and the W-phase because the slot numbers are shifted in the circumferential direction X. The lower surface Y-direction crossing portion of the stator 3 is further crossed below the turn coil end 11b of the unit coil 11 to avoid the interference. As a result, the coil ends are evenly arranged on the upper and lower surfaces in the Y direction, the inner circumferential surface, and the outer circumferential surface of the stator 3, and thus it is possible to make the outer shape of the motor M compact.

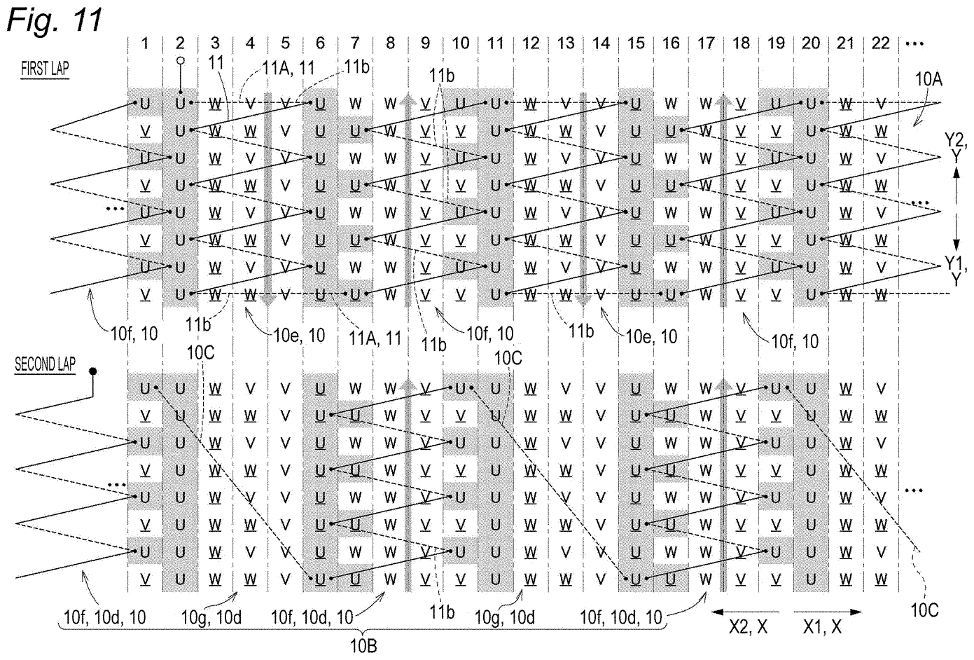

An example of the winding configuration of the fractional slots in which the number of slots per pole and phase is more than ½, and the denominator is equal to or more than 2 when the number of slots per pole and phase is expressed by an irreducible fraction will be described below, as a motor M other than the motor M of 8 poles and 60 slots, with reference to FIGS. 11 to 16. The numbers in the upper part of FIGS. 11 to 16 indicate the slot numbers. The white circles pulled in the Y2 direction in FIGS. 11 to 16 indicate the winding start end. The black circles pulled in the Y2 direction in FIGS. 11 to 16 indicate the winding termination. The solid line connecting the coil sides 11a accommodated in two slots 32 in FIGS. 11 to 16 schematically indicates the coil end arranged on the upper surface of the stator 3. The broken line connecting the coil sides 11a accommodated in two slots 32 schematically indicates the coil end arranged on the lower surface of the stator 3.

FIG. 11 illustrates the winding configuration of a motor M of 8 poles and 36 slots (Nspp=1.5, a=1, b=1, and c=2). Since the motor M of 8 poles and 36 slots has the number of slots per pole, which is 4.5, the short-section pitch is provided for four slots (short-section winding) or the long-section pitch is provided for five slots (long-section winding). As described above, the even-numbered layer of the slot 32 is configured by moving the odd-numbered layer of the slot 32 in the circumferential direction X by a predetermined slot number (here, 4 or 5) configured by an integer closest to the number of slots per pole. Here, when c=2, the movement direction of the even-numbered layer by the predetermined slot number with respect to the odd-numbered layer is either the rotation direction X1 or the reverse rotation direction X2. The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for the a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (8 poles)/c pieces (4 pieces because c=2) are arranged in the circumferential direction X. The continuous-pole coil 10d includes b pieces (b=1) of pole coils 10 that face c pieces (c=2) of magnetic poles and are electrically connected. The continuous-pole coils 10d adjacent to each other in the circumferential direction X are electrically connected by the continuous-pole coil connection portion 10C. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (4 equal parts because c=2), and the continuous-pole coils 10d of the number of magnetic poles (8 poles)/c pieces (4 pieces because c=2), which are adjacent to each other in the circumferential direction X are sequentially and electrically connected to each other and wound. In the continuous-pole coil, b pieces (b=1) of pole coils 10 and a pole coil missing portion 10g are adjacent to each other in no particular order, and the pole coils 10 that are closest to each other in the circumferential direction are electrically connected. The pole coil missing portion is made of blanks corresponding to (c-b) pieces (c-b=1) of the pole coils 10.

In the adjacent pole coil group 10A constituting the coil for the a (a =1) laps, a first pole coil 10e and a second pole coil 10f are alternately arranged adjacent to the circumferential direction X. The first pole coil 10e includes the turn coil end 11b connecting the same layers in the radial direction Y of the slots 32. The second pole coil 10f that does not include the turn coil end 11b connecting the same layers in the radial direction Y of the slots 32. In the pole coil 10, the unit coil 11 other than the same layer connection portion is configured with the short-section pitch in which the turn coil end 11b is inclined (schematic diagram illustrated, practically, bent as illustrated in FIG. 7 and the like) by one layer from the outer radial side to the inner radial side (Y1 direction) in the a-lap direction. In the adjacent pole coil connection portion 11A configured by the unit coil 11 including the turn coil end 11b connecting the same layers in the radial direction Y of the slots 32, the turn coil end 11b is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.5). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, sixth slot in which the number of continuous slots is 1) in which the number of continuous slots constituting a layer-phase band at the bottom (first layer) of the slot 32 is relatively small.

The continuous-pole coil group 10B for a (a+1)th lap ((a+1)=2, second lap) is configured only by the second pole coil 10f that does not include the turn coil end 11b connecting the same layers in the radial direction Y of the slots 32 when the number of blanks between the pole coils 10 is all odd (1). When the number of blanks is odd (1) in the continuous-pole coils 10d of the number of magnetic poles (8 poles)/c pieces (4 pieces because c=2), the continuous-pole coil connection portion 10C across the blanks electrically connects the layer of the slot 32 on the outermost radial side and the layer on the innermost radial side. The continuous-pole coil group 10B for the second lap and subsequent laps is shifted from the adjacent pole coil group 10A for the previous (first) lap in the direction opposite to the a-lap direction by one slot pitch.

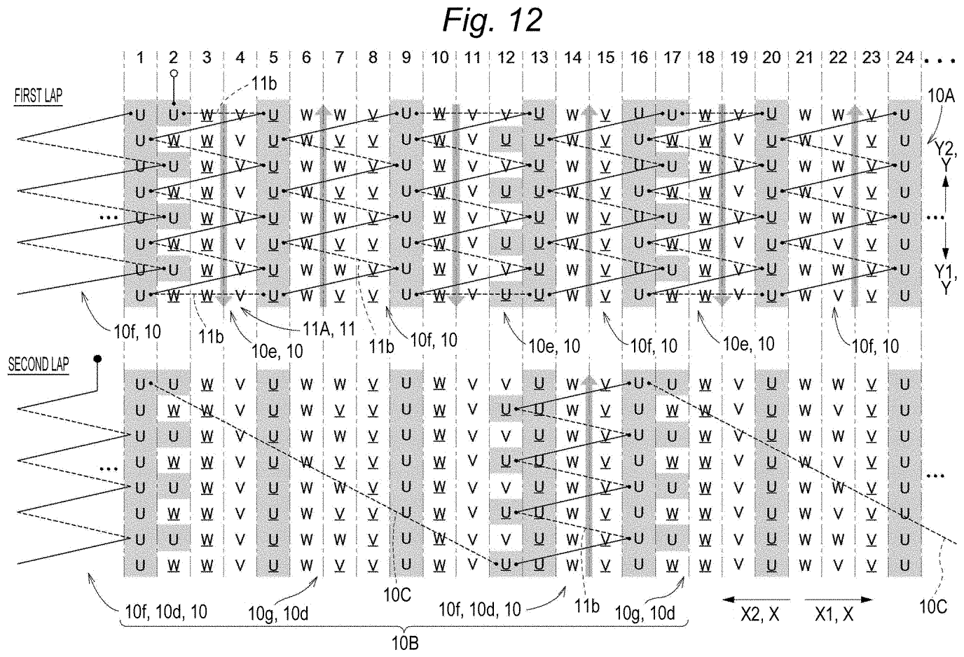

FIG. 12 illustrates the winding configuration of a motor M of 8 poles and 30 slots (Nspp=1.25, a=1, b=1, and c=4). Since the motor M of 8 poles and 30 slots has the number of slots per pole, which is 3.75, the short-section pitch is provided for three slots (short-section winding) or the long-section pitch is provided for four slots (long-section winding). As described above, the even-numbered layer of the slot 32 is configured by moving the odd-numbered layer of the slot 32 in the circumferential direction X by a predetermined slot number (here, 3 or 4) configured by an integer closest to the number of slots per pole. Here, when c is equal to or more than 4 (c=4), the movement direction of the even-numbered layer by the predetermined slot number with respect to the odd-numbered layer is the direction (reverse rotation direction X2) opposite to the a-lap direction (rotation direction X1). The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (8 poles)/c pieces (2 pieces because c=4) are arranged in the circumferential direction X. The continuous-pole coil 10d includes b pieces (b=1) of pole coils 10 that face c pieces (c=4) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (2 equal parts because c=4), and the continuous-pole coils 10d of the number of magnetic poles (8 poles)/c pieces (2 pieces because c=4), which are adjacent to each other in the circumferential direction X are sequentially and electrically connected to each other and wound. In the continuous-pole coil, b pieces (b=1) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c-b) pieces (c-b=3) of the pole coils 10.

In the adjacent pole coil group 10A constituting the coil for the a (a=1) laps, a first pole coil 10e and a second pole coil 10f are alternately arranged adjacent to the circumferential direction X. The first pole coil 10e includes the turn coil end 11b connecting the same layers in the radial direction Y of the slots 32. The second pole coil 10f that does not include the turn coil end 11b connecting the same layers in the radial direction Y of the slots 32. In the pole coil 10, the unit coil 11 other than the same layer connection portion is configured with the long-section pitch in which the turn coil end 11b is inclined (schematic diagram illustrated, practically, bent as illustrated in FIG. 7 and the like) by one layer from the outer radial side to the inner radial side (Y1 direction) in the a-lap direction. In the adjacent pole coil connection portion 11A configured by the unit coil 11 including the turn coil end 11b connecting the same layers in the radial direction Y of the slots 32, the turn coil end 11b is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.25). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, fifth slot in which the number of continuous slots is 1) in which the number of continuous slots constituting a layer-phase band at the bottom (first layer) of the slot 32 is relatively small.

The continuous-pole coil group 10B for the (a+1)th lap ((a+1)=2, second lap) is configured only by the second pole coil 10f that does not include the turn coil end 11b connecting the same layers of the slot 32 in the radial direction Ys when the number of blanks between the pole coils 10 is all odd (3). When the number of blanks is odd (3) in the continuous-pole coils 10d of the number of magnetic poles (8 poles)/c pieces (2 pieces because c=4), the continuous-pole coil connection portion 100 across the blanks electrically connects the layer of the slot 32 on the outermost radial side and the layer on the innermost radial side. The continuous-pole coil group 10B for the second lap and subsequent laps is shifted from the adjacent pole coil group 10A for the previous (first) lap in the direction opposite to the a-lap direction by one slot pitch.

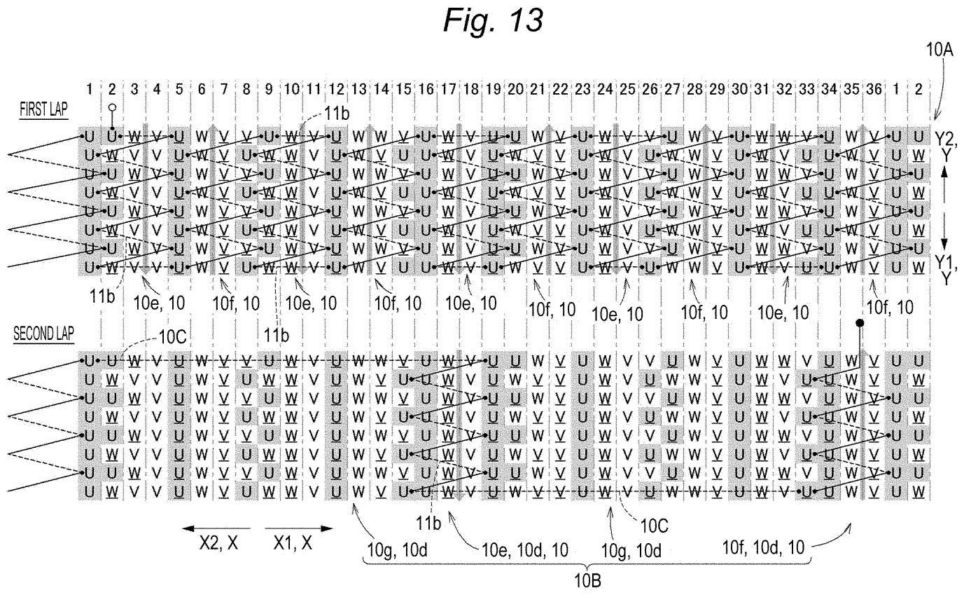

FIG. 13 illustrates the winding configuration of a motor M of 10 poles and 36 slots (Nspp=1.2, a=1, b=1, and c=5). Since the motor M of 10 poles and 36 slots has the number of slots per pole, which is 3.6, the short-section pitch is provided for three slots (short-section winding) or the long-section pitch is provided for four slots (long-section winding). As described above, the even-numbered layer of the slot 32 is configured by moving the odd-numbered layer of the slot 32 in the circumferential direction X by a predetermined slot number (here, 3 or 4) configured by an integer closest to the number of slots per pole. Here, when c is equal to or more than 4 (c=5), the movement direction of the even-numbered layer by the predetermined slot number with respect to the odd-numbered layer is the direction (reverse rotation direction X2) opposite to the a-lap direction (rotation direction X1). The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (10 poles)/c pieces (2 pieces because c=5) are arranged in the circumferential direction X. The continuous-pole coil 10d includes b pieces (b=1) of pole coils 10 that face c pieces (c=5) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (10 poles)/c (2 equal parts because c=5), and the continuous-pole coils 10d of the number of magnetic poles (10 poles)/c pieces (2 pieces because c=5), which are adjacent to each other in the circumferential direction X are sequentially and electrically connected to each other and wound. In the continuous-pole coil, b pieces (b=1) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c-b) pieces (c-b=4) of the pole coils 10.

In the adjacent pole coil group 10A constituting the coil for the a (a=1) laps, a first pole coil 10e and a second pole coil 10f are alternately arranged adjacent to the circumferential direction X. The first pole coil 10e includes the turn coil end 11b connecting the same layers in the radial direction Y of the slots 32. The second pole coil 10f that does not include the turn coil end 11b connecting the same layers in the radial direction Y of the slots 32. In the pole coil 10, the unit coil 11 other than the same layer connection portion is configured with the long-section pitch in which the turn coil end 11b is inclined or bent by one layer from the outer radial side to the inner radial side (Y1 direction) in the a-lap direction. In the adjacent pole coil connection portion 11A configured by the unit coil 11 including the turn coil end 11b connecting the same layers in the radial direction Y of the slots 32, the turn coil end 11b is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.2). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, fifth slot in which the number of continuous slots is 1) in which the number of continuous slots constituting a layer-phase band at the bottom (first layer) of the slot 32 is relatively small.

When the number of blanks between the pole coils 10 is all even (4), the continuous-pole coil group 10B for the (a+1)th lap ((a+1)=2, second lap) is configured by the second pole coil 10f that does not include the turn coil end 11b connecting the same layers of the slot 32 in the radial direction Y, and the first pole coil 10e including the turn coil end 11b connecting the same layers of the slot 32 in the radial direction. When the number of blanks is even (4) in the continuous-pole coils 10d of the number of magnetic poles (10 poles)/c pieces (2 pieces because c=5), the continuous-pole coil connection portion 10C across the blanks electrically connects the layers of the slot 32 on the outermost radial side with each other or the layers on the innermost radial side with each other. The continuous-pole coil group 10B for the second lap and subsequent laps is shifted from the adjacent pole coil group 10A for the previous (first) lap in the direction opposite to the a-lap direction by one slot pitch.

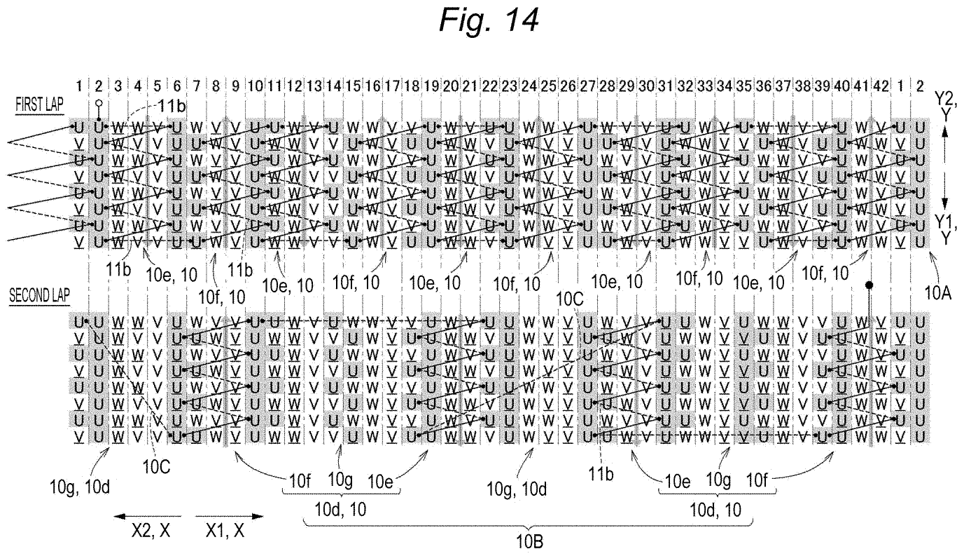

FIG. 14 illustrates the winding configuration of a motor M of 10 poles and 42 slots (Nspp=1.4, a=1, b=2, and c=5). Since the motor M of 10 poles and 42 slots has the number of slots per pole, which is 4.2, the short-section pitch is provided for four slots (short-section winding) or the long-section pitch is provided for five slots (long-section winding). As described above, the even-numbered layer of the slot 32 is configured by moving the odd-numbered layer of the slot 32 in the circumferential direction X by a predetermined slot number (here, 4 or 5) configured by an integer closest to the number of slots per pole. Here, when c is equal to or more than 4 (c=5), the movement direction of the even-numbered layer by the predetermined slot number with respect to the odd-numbered layer is the direction (reverse rotation direction X2) opposite to the a-lap direction (rotation direction X1). The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (10 poles)/c pieces (2 pieces because c=5) are arranged in the circumferential direction X. The continuous-pole coil 10d includes b pieces (b=2) of pole coils 10 that face c pieces (c=5) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (10 poles)/c (2 equal parts because c=5), and the continuous-pole coils 10d of the number of magnetic poles (10 poles)/c pieces (2 pieces because c=5), which are adjacent to each other in the circumferential direction X are sequentially and electrically connected to each other and wound. In the continuous-pole coil, b pieces (b=2) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c-b) pieces (c-b=3) of the pole coils 10. Here, in the continuous-pole coil 10d, the closest pole coils 10 adjacent to each other in the circumferential direction X are electrically and sequentially connected when two or more pole coils 10 are provided.

In the adjacent pole coil group 10A constituting the coil for the a (a=1) laps, a first pole coil 10e and a second pole coil 10f are alternately arranged adjacent to the circumferential direction X. The first pole coil 10e includes the turn coil end 11b connecting the same layers in the radial direction Y of the slots 32. The second pole coil 10f that does not include the turn coil end 11b connecting the same layers in the radial direction Y of the slots 32. In the pole coil 10, the unit coil 11 other than the same layer connection portion is configured with the short-section pitch in which the turn coil end 11b is inclined or bent by one layer from the outer radial side to the inner radial side (Y1 direction) in the a-lap direction. In the adjacent pole coil connection portion 11A configured by the unit coil 11 including the turn coil end 11b connecting the same layers in the radial direction Y of the slots 32, the turn coil end 11b is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.4). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, sixth slot in which the number of continuous slots is 1) in which the number of continuous slots constituting a layer-phase band at the bottom (first layer) of the slot 32 is relatively small.

When an odd number (1) and an even number (2) are mixed as the number of blanks between the pole coils 10, the continuous-pole coil group 10B for the (a+1)th lap ((a+1)=2, second lap) is configured by the second pole coil 10f that does not include the turn coil end 11b connecting the same layers of the slot 32 in the radial direction Y, and the first pole coil 10e including the turn coil end 11b connecting the same layers of the slot 32 in the radial direction. When the number of blanks is odd (1) in the continuous-pole coils 10d of the number of magnetic poles (10 poles)/c pieces (2 pieces because c=5), the continuous-pole coil connection portion 100 across the blanks electrically connects the layer of the slot 32 on the outermost radial side and the layer on the innermost radial side. When the number of blanks is even (2), the pole coil connection portion that sequentially and electrically connects the pole coils 10 in the continuous-pole coils 10d across the blanks connects the layers of the slots 32 on the outermost radial side (first layers of the 10th slot and the 22nd slot) with each other or the layers of the slots 32 on the innermost radial side (eighth layers of the 27th slot and the 39th slot). The continuous-pole coil group 10B for the second lap and subsequent laps is shifted from the adjacent pole coil group 10A for the previous (first) lap in the direction opposite to the a-lap direction by one slot pitch.

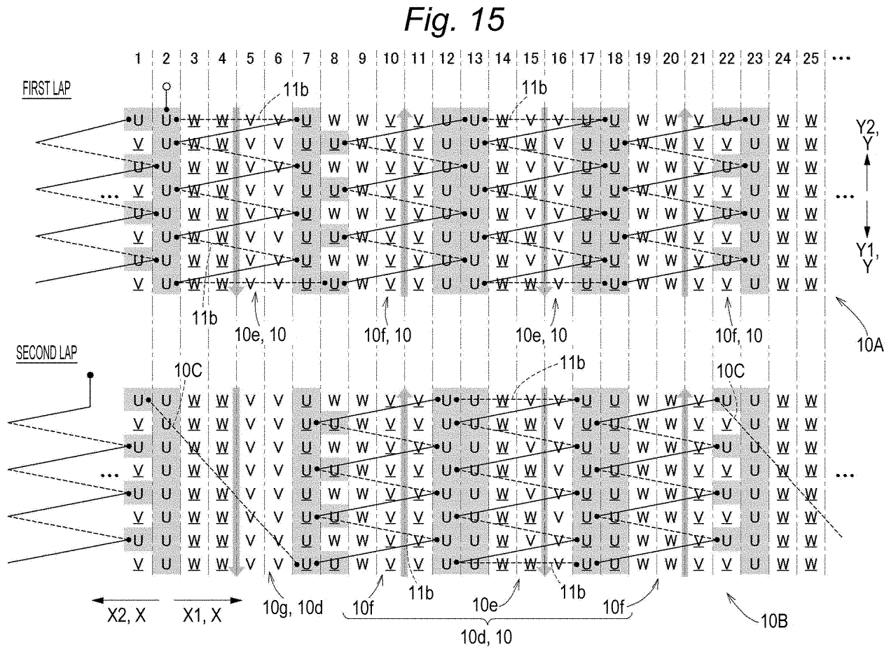

FIG. 15 illustrates the winding configuration of a motor M of 8 poles and 42 slots (Nspp=1.75, a=1, b=3, and c=4). Since the motor M of 8 poles and 42 slots has the number of slots per pole, which is 5.25, the short-section pitch is provided for five slots (short-section winding) or the long-section pitch is provided for six slots (long-section winding). As described above, the even-numbered layer of the slot 32 is configured by moving the odd-numbered layer of the slot 32 in the circumferential direction X by a predetermined slot number (here, 5 or 6) configured by an integer closest to the number of slots per pole. Here, when c is equal to or more than 4 (c=4), the movement direction of the even-numbered layer by the predetermined slot number with respect to the odd-numbered layer is the direction (reverse rotation direction X2) opposite to the a-lap direction (rotation direction X1). The layer-phase band arrangement of even-numbered layers or the layer-phase band arrangement of the odd-numbered layers have the same configuration in the circumferential direction X.

As illustrated in FIG. 11, the coil for the a laps (a=1) is configured by an adjacent pole coil group 10A in which pole coils 10 in which the magnetic poles of the rotor 2 have the same phase as each other, and current directions are opposite to each other at the poles adjacent to each other among the magnetic poles of the rotor 2, that is, the current directions are the same as each other at the poles (one pole apart) of the magnetic poles of the rotor 2 are electrically connected to each other while being arranged to be adjacent to each other. In other words, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. The coil of the (a+1)th lap ((a+1)=2, second lap) includes the continuous-pole coil group 10B in which the continuous-pole coils 10d of which the number is the number of magnetic poles (8 poles)/c pieces (2 pieces because c=4) are arranged in the circumferential direction X. The continuous-pole coil 10d includes b pieces (b=3) of pole coils 10 that face c pieces (c=4) of magnetic poles and are electrically connected. The continuous-pole coils 10d adjacent to each other in the circumferential direction X are electrically connected by the continuous-pole coil connection portion 10C. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (2 equal parts because c=4), and the continuous-pole coils 10d of the number of magnetic poles (8 poles)/c pieces (2 pieces because c=4), which are adjacent to each other in the circumferential direction X are sequentially and electrically connected to each other and wound. In the continuous-pole coil, b pieces (b=3) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c-b) pieces (c-b=1) of the pole coils 10. Here, in the continuous-pole coil 10d, the closest pole coils 10 adjacent to each other in the circumferential direction X are electrically and sequentially connected when two or more (b=3) pole coils 10 are provided.

In the adjacent pole coil group 10A constituting the coil for the a (a=1) laps, a first pole coil 10e and a second pole coil 10f are alternately arranged adjacent to the circumferential direction X. The first pole coil 10e includes the turn coil end 11b connecting the same layers in the radial direction Y of the slots 32. The second pole coil 10f that does not include the turn coil end 11b connecting the same layers in the radial direction Y of the slots 32. In the pole coil 10, the unit coil 11 other than the same layer connection portion is configured with the short-section pitch in which the turn coil end 11b is inclined or bent by one layer from the outer radial side to the inner radial side (Y1 direction) in the a-lap direction. In the adjacent pole coil connection portion 11A configured by the unit coil 11 including the turn coil end 11b connecting the same layers in the radial direction Y of the slots 32, the turn coil end 11b is arranged on the outermost radial side and the innermost radial side of the slot 32. The phase starting end of the coil is pulled out from the slot 32 (second slot) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.7). The phase band including the slot 32 for pulling out the phase starting end is a phase band (for example, first and second slots in which the number of continuous slots is 2) in which the number of odd-numbered (first) continuous slots at the shortest distance in the circumferential direction X is relatively large with respect to a phase band (for example, sixth slot in which the number of continuous slots is 1) in which the number of continuous slots constituting a layer-phase band at the bottom (first layer) of the slot 32 is relatively small.

When an odd number (1) and an even number (0) are mixed as the number of blanks between the pole coils 10, the continuous-pole coil group 10B for the (a+1)th lap ((a+1)=3, third lap) is configured by the second pole coil 10f that does not include the turn coil end 11b connecting the same layers of the slots 32 in the radial direction Y, and the first pole coil 10e including the turn coil end 11b connecting the same layers of the slots 32 in the radial direction. When the number of blanks is odd (1) in the continuous-pole coils 10d of the number of magnetic poles (8 poles)/c pieces (2 pieces because c=4), the continuous-pole coil connection portion 100 across the blanks electrically connects the layer of the slot 32 on the outermost radial side and the layer on the innermost radial side. The continuous-pole coil group 10B for the second lap and subsequent laps is shifted from the adjacent pole coil group 10A for the previous (first) lap in the direction opposite to the a-lap direction by one slot pitch.

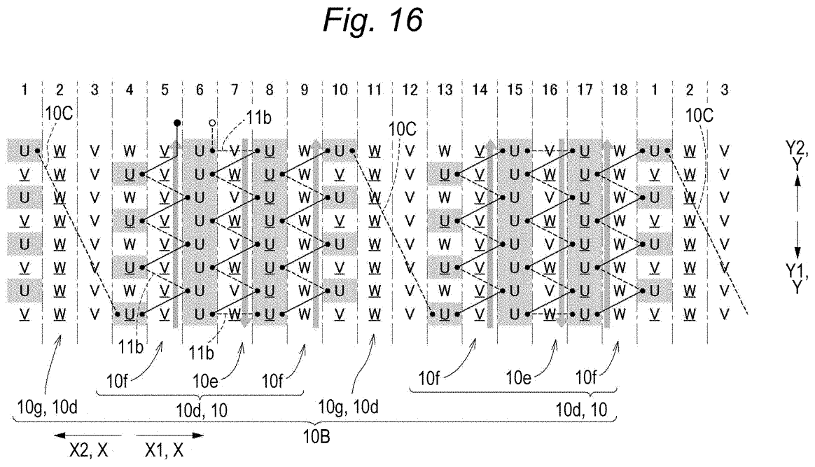

FIG. 16 illustrates the winding configuration of a motor M of 8 poles and 18 slots (Nspp=0.75, a=0, b=3, and c=4). Since the motor M of 8 poles and 18 slots has the number of slots per pole, which is 2.25, the short-section pitch is provided for two slots (short-section winding) or the long-section pitch is provided for three slots (long-section winding). As described above, the even-numbered layer of the slot 32 is configured by moving the odd-numbered layer of the slot 32 in the circumferential direction X by a predetermined slot number (here, 2 or 3) configured by an integer closest to the number of slots per pole. Here, when c is equal to or more than 4 (c=4), the movement direction of the even-numbered layer by the predetermined slot number with respect to the odd-numbered layer is the direction (reverse rotation direction X2) opposite to the (a+1)-lap direction (rotation direction X1). The layer-phase band arrangement of even-numbered layers or the layer-phase band arrangement of the odd-numbered layers have the same configuration in the circumferential direction X.

As illustrated in FIG. 16, there is no coil for the a laps (a=0). The coil of the (a+1)th lap ((a+1)=1, first lap) includes the continuous-pole coil group 10B in which the continuous-pole coils 10d of which the number is the number of magnetic poles (8 poles)/c pieces (2 pieces because c=4) are arranged in the circumferential direction X. The continuous-pole coil 10d includes b pieces (b=3) of pole coils 10 that face c pieces (c=4) of magnetic poles and are electrically connected. The continuous-pole coils 10d adjacent to each other in the circumferential direction X are electrically connected by the continuous-pole coil connection portion 100. In other words, the coil of the (a+1)th lap is configured by the continuous-pole coil group 10B in which the continuous-pole coil 10d is arranged in a range obtained by equally dividing the entire circumference of the stator 3 by the number of magnetic poles (8 poles)/c (2 equal parts because c=4), and the continuous-pole coils 10d of the number of magnetic poles (8 poles)/c pieces (2 pieces because c=4), which are adjacent to each other in the circumferential direction X are sequentially and electrically connected to each other and wound. In the continuous-pole coil, b pieces (b=3) of pole coils 10 and a pole coil missing portion 10g are adjacent to each other in no particular order, and the pole coils 10 that are closest to each other in the circumferential direction X are electrically connected. The pole coil missing portion is made of blanks corresponding to (c-b) pieces (c-b=1) of the pole coils 10. The phase starting end of the coil is pulled out from the slot 32 (sixth slot) at the end of a phase band on the (a+1)-lap direction side. In the phase band, the number of continuous slots being the number of slots 32 in which coil sides 11a that are continuous in the circumferential direction X and have the same phase are arranged at the bottom (first layer) of the slot 32 is the larger integer (1) of the integers (0 and 1) closest to Nspp (0.75). The phase band including the slot 32 for pulling out the phase starting end is a phase band (for example, sixth slot in which the number of continuous slots is 1) in which the number of odd-numbered (first) continuous slots at the shortest distance in the circumferential direction X is relatively large with respect to a phase band (for example, intermediate central portion between the third slot and the fourth slot in which the number of continuous slots is 0 (that is, in the original phase arrangement order, the phases are arranged in order of the U phase, the V phase, and the W phase in a right direction in FIG. 16 (for example, first layers of slots having the slot numbers of 1 to 3), but, with Nspp (0.75), the three-phase configuration arrangement is established by omitting the U phase which is to be normally arranged between the V phase of the third slot and the W phase of the fourth slot, that is, setting the U phase to 0. Thus, the virtual slot position of the omitted U phase in which the number of continuous slots is 0 is the intermediate central portion between the third slot and the fourth slot) in which the number of continuous slots constituting a layer-phase band at the bottom (first layer) of the slot 32 is relatively small.

When an odd number (1) and an even number (0) are mixed as the number of blanks between the pole coils 10, the continuous-pole coil group 10B for the (a+1)th lap ((a+1)=1, first lap) is configured by the second pole coil 10f that does not include the turn coil end 11b connecting the same layers of the slot 32 in the radial direction Y, and the first pole coil 10e including the turn coil end 11b connecting the same layers of the slot 32 in the radial direction. In the pole coil 10, the unit coil 11 other than the same layer connection portion is configured with the short-section pitch in which the turn coil end 11b is inclined or bent by one layer from the outer radial side to the inner radial side (Y1 direction) in the (a+1)-lap direction. Further, when the number of blanks is odd (1) in the continuous-pole coils 10d of the number of magnetic poles (8 poles)/c pieces (2 pieces because c=4), the continuous-pole coil connection portion 10C across the blanks electrically connects the layer of the slot 32 on the outermost radial side and the layer on the innermost radial side.

As described above, in the motor M in this embodiment, in the fractional slot configuration in which the number of slots per pole and phase is more than ½, and the denominator is equal to or more than 2, the coil for a laps is configured by the adjacent pole coil group 10A in which, in a state where pole coils 10 of which the number is equal to the number of magnetic poles of the rotor 2 are arranged to be adjacent to each other over an entire circumference of the stator 3, the pole coils 10 adjacent to each other in the circumferential direction X are electrically and sequentially connected to each other to make one lap. In the adjacent pole coil group 10A constituting the coil for the a laps, a first pole coil 10e and a second pole coil 10f are alternately arranged adjacent to the circumferential direction X. The first pole coil 10e includes the turn coil end 11b connecting the same layers of the slot 32 in the radial direction Y. The second pole coil 10f that does not include the turn coil end 11b connecting the same layers of the slot 32 in the radial direction Y. The phase starting end of the coil is pulled out from the slot 32 at the end of a phase band on the a-lap direction side ((a+1)-lap direction when a=0). In the phase band, the number of continuous slots being the number of slots 32 in which coil sides 11a that are continuous in the circumferential direction X and have the same phase are arranged at the bottom (first layer) of the slot 32 is the larger integer closest to Nspp. The phase band including the slot 32 for pulling out the phase starting end is a phase band (the number of continuous slots is 1 when a=0) in which the number of odd-numbered continuous slots at the shortest distance in the circumferential direction X is relatively large with respect to a phase band (blank in which the number of continuous slots is 0 when a=0) in which the number of continuous slots constituting a layer-phase band at the bottom (first layer) of the slot 32 is relatively small.

In the motor M in this embodiment, in the fractional slot configuration in which the number of slots per pole and phase is more than ½, and the denominator is equal to or more than 2, the coil of the (a+1)th lap is configured by the continuous-pole coil group 10B in which the continuous-pole coil 10d is arranged in a range obtained by equally dividing the entire circumference of the stator 3 by the number of magnetic poles/c, and the continuous-pole coils 10d of the number of magnetic poles/c pieces, which are adjacent to each other in the circumferential direction X are sequentially and electrically connected to each other and wound. In the continuous-pole coil, b pieces of pole coils 10 and a pole coil missing portion 10g are adjacent to each other in no particular order, and the pole coils 10 that are closest to each other in the circumferential direction X are electrically connected. The pole coil missing portion is made of blanks corresponding to (c-b) pieces of the pole coils 10. When the number of blanks between the pole coils 10 is all odd, the continuous-pole coil group 10B for the (a+1)th lap is configured only by the second pole coil 10f that does not include the turn coil end 11b connecting the same layers of the slot 32 in the radial direction Y. When the number of blanks between the pole coils 10 is all even (including zero) or when an odd number and an even number (including zero) are mixed as the number of blanks between the pole coils 10, the continuous-pole coil group 10B for the (a+1)th lap is configured by the second pole coil 10f that does not include the turn coil end 11b connecting the same layers of the slot 32 in the radial direction Y, and the first pole coil 10e including the turn coil end 11b connecting the same layers of the slot 32 in the radial direction Y. Further, the pole coil connection portion that sequentially and electrically connects the pole coils 10 in the continuous-pole coils 10d across the blanks or the pole coil connection portion (continuous-pole coil connection portion 100) that sequentially and electrically connects the pole coils 10 between the continuous-pole coils 10d connects the layer of the slots 32 on the outermost radial side and the layer of the slots 32 on the innermost radial side when the number of blanks is odd, and connects the layers of the slots 32 on the outermost radial side with each other or the layers of the slots 32 on the innermost radial side when the number of blanks is even (not including zero).

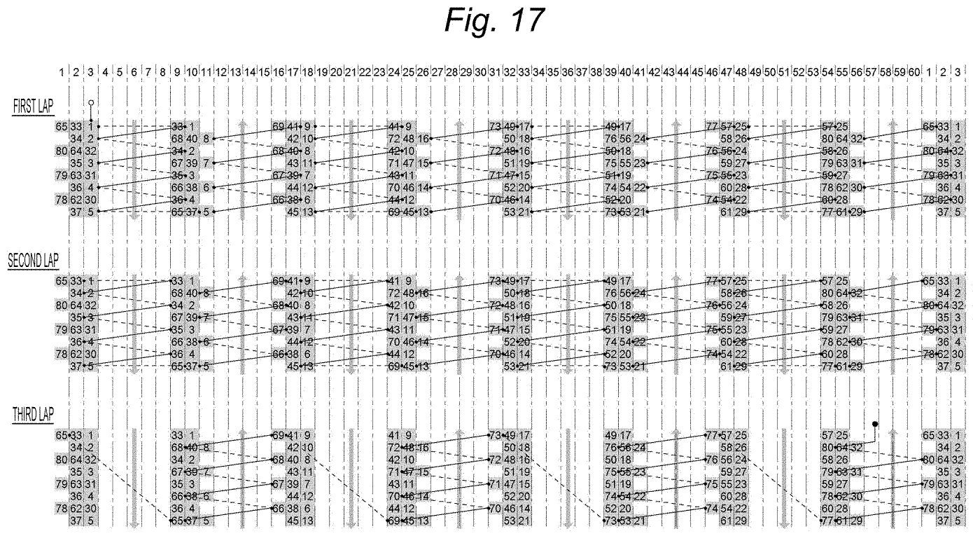

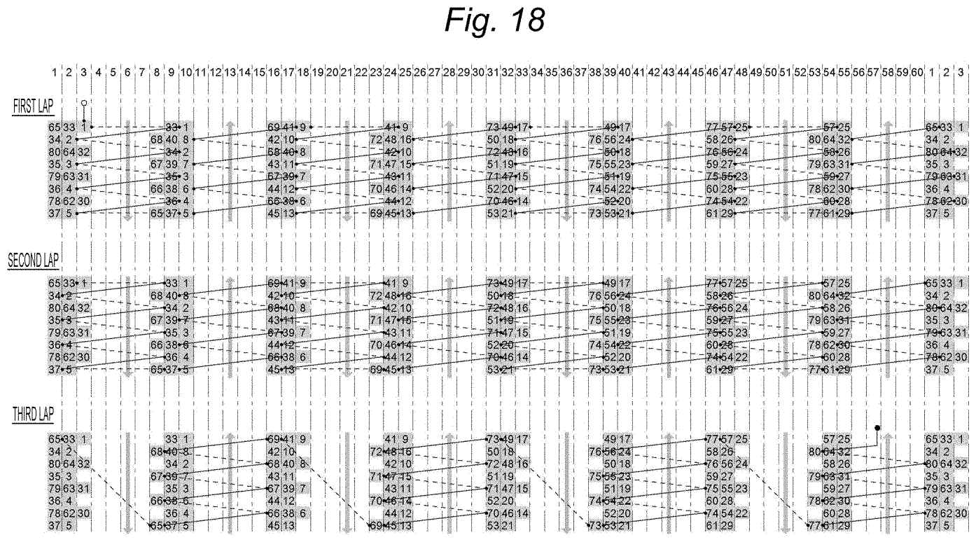

A point that, in a motor M of 8 poles and 60 slots, in the pole coil 10 that occupies most of the windings, the turn coil end 11b other than the same layer connection portion of the unit coil 11 may take both the short-section pitch and the long-section pitch will be described below with reference to FIGS. 17 and 18. The numbers in the upper part in FIGS. 17 and 18 indicate the slot numbers. The white circles in FIGS. 17 and 18 indicate the winding start end. The black circles in FIGS. 17 and 18 indicate the winding termination. The number in the colored part in FIGS. 17 and 18 indicates the turn order of the U phase. The solid line indicates the coil arranged on the upper surface of the stator 3. The broken line indicates the coil arranged on the lower surface of the stator 3.

FIG. 17 corresponds to FIGS. 3 to 5. In the pole coil 10, the turn coil end 11b (solid line) other than the same layer connection portion of the unit coil 11 is configured with the short-section pitch (7 slot pitches). In FIG. 18, in the pole coil 10, the turn coil end 11b (solid line) other than the same layer connection portion of the unit coil 11 is configured with the long-section pitch (8 slot pitches).

In FIG. 18, the configuration is made with a phase band arrangement in which the four sets of two-layer units 11U illustrated in FIG. 17 are shifted in the rotation direction X1 by the short-section pitch (7 slot pitches), and the two layers of the two-layer unit 11U in each set are replaced in the radial direction Y. FIG. 18 illustrates the optimum turn order of the unit coils 11 in this phase band arrangement.

In the first turn as the start turn of the first lap, in the unit coil 11 for the adjacent pole coil connection portion 11A on the outermost radial side, the coil side 11a is inserted into the first layer of the third slot and the first layer of the 10th slot so that the turn coil end 11b being one coil end is arranged below the stator 3. That is, the turn coil end 11b of the unit coil 11 at the adjacent pole coil connection portion 11A on the outermost radial side has a short-section pitch (7 slot pitches) as in FIG. 17. In the second turn, in the unit coil 11 of the pole coil 10, the coil side 11a is inserted into the second layer of the second slot and the third layer of the 10th slot so that the turn coil end 11b being one coil end is arranged below the stator 3. That is, differing from FIG. 17, the turn coil end 11b of the unit coil 11 in the pole coil 10 has a long-section pitch (8 slot pitches).

The pole coil 10 similar to that in the second turn continues from the third turn to the fourth turn. In the fifth turn, in the unit coil 11 for the adjacent pole coil connection portion 11A on the innermost radial side, the coil side 11a is inserted into the eighth layer of the second slot and the eighth layer of the 10th slot so that the turn coil end 11b being one coil end is arranged below the stator 3. That is, the turn coil end 11b of the unit coil 11 at the adjacent pole coil connection portion 11A on the innermost radial side has a long-section pitch (8 slot pitches) as in FIG. 17. The pole coil 10 similar to that in the second turn to the fourth turn continues from the sixth turn to the eighth turn. Turns of the first turn to the eighth turn are repeated from the ninth turn to the 16th turn, from the 17th turn to the 24th turn, and from the 25th turn to the 32nd turn.

In the 33rd turn as the start turn of the second lap, in the unit coil 11 for the adjacent pole coil connection portion 11A on the outermost radial side, the coil side 11a is inserted into the first layer of the second slot and the first layer of the ninth slot so that the turn coil end 11b being one coil end is arranged below the stator 3. That is, the turn coil end 11b of the unit coil 11 at the adjacent pole coil connection portion 11A on the outermost radial side has a short-section pitch (7 slot pitches) as in FIG. 17. The second lap is completed by repeating turns of the 34th turn to a 64th turn are made by repetition in a similar manner to that for the turns of the second turn to the 32nd turn.

In the 65th turn as the start turn of the third lap, in the unit coil 11 for the continuous-pole coil connection portion 10C, the coil side 11a is inserted into the first layer of the first slot and the eighth layer of the eighth slot so that the turn coil end 11b for one coil end is arranged below the stator 3. That is, differing from FIG. 17, the turn coil end 11b of the unit coil 11 in the continuous-pole coil connection portion 100 has a short-section pitch (7 slot pitches).

Turns of the 66th turn to the 68th turn are repeated in the similar manner to that for the above-described turns of the sixth turn to the eighth turn. Turns of the 70th turn to the 73rd turn and turns of the 74th turn to the 77th turn are repeated in the similar manner to that for the turns of the 66th turn to the 69th turn. Turns of the 78th turn to the 79th turn are made in the similar manner to that for the turns of the 66th turn to the 67th turn. Finally, in the 80th turn, in the unit coil 11 of the pole coil 10, the coil side 11a is inserted into the second layer of the 53rd slot and the third layer of the first slot so that the turn coil end 11b being one coil end is arranged below the stator 3. That is, differing from FIG. 17, the turn coil end 11b of the unit coil 11 in the pole coil 10 has a long-section pitch (8 slot pitches).

As described above, in the phase band arrangement illustrated in FIG. 18, in the pole coil 10, the 60 unit coils 11 are configured with the long-section pitch as the slot pitch of the turn coil end 11b other than the same layer connection portion. The turn coil end 11b is inclined by one layer from the outer radial side of the slot 32 to the inner radial side (Y1 direction) in the a-lap direction (schematic diagram illustrated, practically, bent as illustrated in FIG. 7 and the like). The unit coil 11 for eight adjacent pole coil connection portions 11A on the outermost radial side and the unit coil 11 for four continuous-pole coil connection portions 100 are configured with the short-section pitch as the slot pitch of the turn coil end 11b. The unit coil 11 for eight adjacent pole coil connection portions 11A on the innermost radial side is configured with the long-section pitch as the slot pitch of the turn coil end 11b. As described above, 68 unit coils 11 have the turn coil end 11b of the long-section pitch, and 12 unit coils 11 have the turn coil end 11b of the short-section pitch. Thus, most of the unit coils are configured by the unit coils 11 of the long-section pitch. Thus, with the phase band arrangement illustrated in FIG. 17 similar to FIGS. 3 to 6, it is possible to minimize the total coil length and reduce the manufacturing cost.

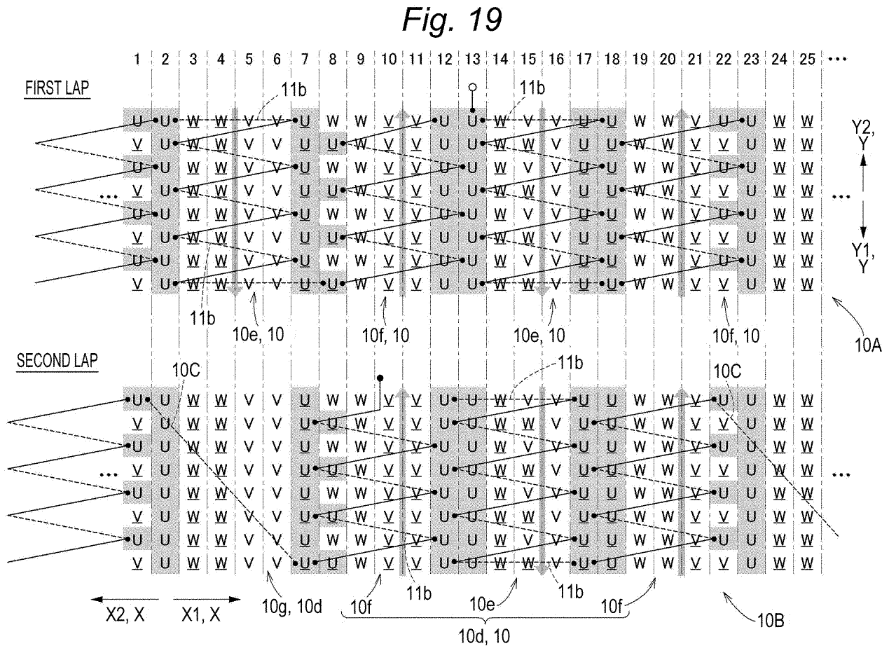

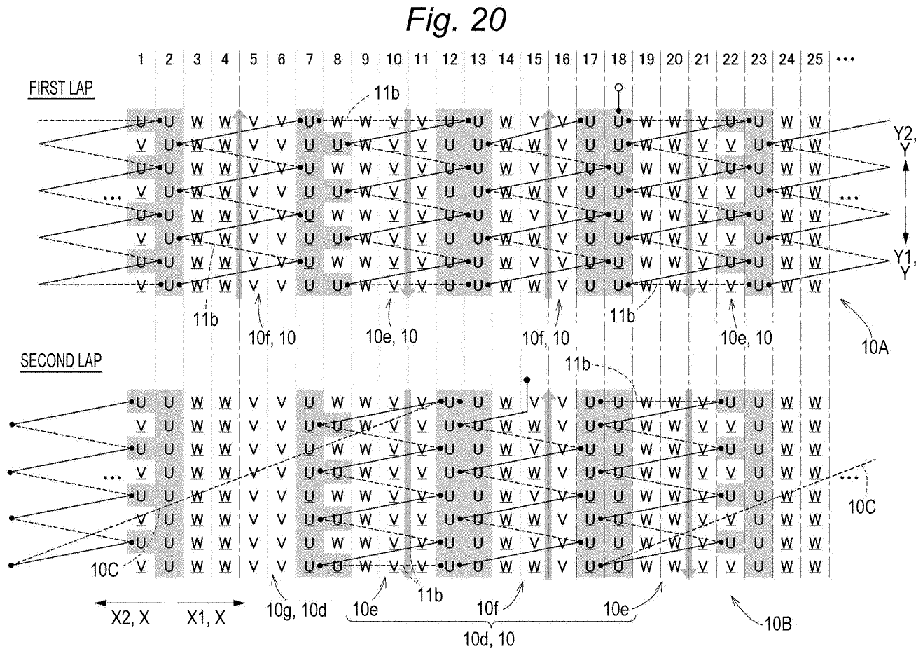

With reference to FIGS. 19 and 20, the phase starting end position of the coil will be verified as a modification example of the winding configuration of the motor M with 8 poles and 42 slots (Nspp=1.75, a=1, b=3, c=4) illustrated in FIG. 15. In any case, the phase starting end of the coil illustrated in FIGS. 19 and 20 is pulled out from the slot 32 (13th slot in FIG. 19, 18th slot in FIG. 20) at the end of a phase band on the a-lap direction side. In the phase band, the number of continuous slots being the number of slots 32 in which coil sides 11a that are continuous in the circumferential direction X and have the same phase are arranged at the bottom (first layer) of the slot 32 is the larger integer (2) of the integers (1 and 2) closest to Nspp (1.75).

In FIG. 19, the phase band including the slot 32 for pulling out the phase starting end is a phase band (12th and 13th slots in which the number of continuous slots is 2) in which the number of odd-numbered (first) continuous slots at the shortest distance in the circumferential direction X is relatively large with respect to a phase band (sixth slot in which the number of continuous slots is 1) in which the number of continuous slots constituting a layer-phase band at the bottom (first layer) of the slot 32 is relatively small. In FIG. 20, the phase band including the slot 32 for pulling out the phase starting end is a phase band (17th and 18th slots in which the number of continuous slots is 2) in which the number of even-numbered (second) continuous slots in the circumferential direction X is relatively large with respect to a phase band (sixth slot in which the number of continuous slots is 1) in which the number of continuous slots constituting a layer-phase band at the bottom (first layer) of the slot 32 is relatively small.

In all the above-described embodiments, among the pole coils 10 constituting the phase coil, the first pole coil 10e including the turn coil end 11b connecting the same layers in the radial direction Y of the slots 32 is the pole coil 10 of an odd number counting from the phase starting end. The second pole coil 10f that does not include the turn coil end 11b connecting the same layers in the radial direction Y of the slots 32 is the pole coil 10 of an even number counting from the phase starting end. Here, the circumferential direction X of one pole coil 10 means going back and forth at a predetermined coil pitch. In the depth direction (radial direction Y) of the slot 32, the layers adjacent in the same direction are sequentially joined. In the arrangement of the layer-phase band in the depth direction of the slot 32, the even-numbered layer from the bottom of the slot 32 with respect to the odd-numbered layer is moved in the circumferential direction X by the number of slots, which is any one of integers closest to the number of slots per pole (Nspp×3). Here, the layer-phase band arrangement of the odd-numbered layers and the layer-phase band arrangement of the even-numbered layers are the same in the circumferential direction X.

In such a winding configuration, in the examples of FIGS. 15 and 19, the coil end length of the continuous-pole coil connection portion 100 is equivalent to one pole coil 10. In the example of FIG. 20, the coil end length of the continuous-pole coil connection portion 100 is equivalent to three pole coils 10. Thus, in the examples illustrated in FIGS. 15 and 19, it is possible to reduce the coil end length. That is, the phase band including the slot 32 for pulling out the phase starting end is preferably a phase band in which the number of odd-numbered continuous slots at the shortest distance in the circumferential direction X is relatively large with respect to a phase band in which the number of continuous slots constituting a layer-phase band at the bottom (first layer) of the slot 32 is relatively small.

The characteristic configuration of the rotary electric machine according to this disclosure is that the rotary electric machine includes a stator that has a plurality of slots accommodating a coil having a lap winding configuration made of a segment conductor, and a rotor that faces the stator and has a plurality of magnetic poles, and has a fractional slot configuration in which the number of slots per pole and phase, which is obtained by dividing the number of the slots of the stator by the number of phases and the number of the magnetic poles of the rotor, is more than ½, and a denominator is equal to or more than 2 in an irreducible fraction expression. When the irreducible fraction expression of the number of slots per pole and phase is set as (a+b/c) where a indicates zero or a positive integer, and b and c indicate a positive integer and b<c, the coil for a laps is configured by an adjacent pole coil group in which pole coils adjacent to each other in a circumferential direction are electrically and sequentially connected to each other while the pole coils are arranged to be adjacent to each other over an entire circumference of the stator, the pole coils of which the number is equal to the number of magnetic poles of the rotor, and the coil of a (a+1)th lap is configured by a continuous-pole coil group in which a continuous-pole coil is arranged in a range obtained by equally dividing the entire circumference by the number of magnetic poles/c, and the continuous-pole coils of the number of magnetic poles/c, which are adjacent to each other in the circumferential direction are sequentially and electrically connected to each other and wound, the continuous-pole coil in which b pieces of pole coils and a pole coil missing portion are adjacent to each other in no particular order, and the pole coils that are closest to each other in the circumferential direction are electrically connected, and the pole coil missing portion being made of blanks corresponding to (c-b) pieces of the pole coils, where the a laps are made in the same direction.

With this configuration, it is possible to realize a rotary electric machine having a fractional slot configuration using a segment conductor, with a lap winding configuration.

Another characteristic configuration is that the unit coil of the segment conductor includes a pair of coil sides accommodated in the two slots and one turn coil end that electrically connects the pair of coil sides to form one turn, in the adjacent pole coil group, the pole coil including the turn coil end and the pole coil not including the turn coil end are alternately arranged in the circumferential direction, the turn coil end connecting the same layers of the slots in a radial direction, and the continuous-pole coil group is configured by only the pole coil not including the turn coil end that connects the same layers of the slots in the radial direction when the number of blanks between the pole coils is all odd, and is configured by the pole coil not including the turn coil end and the pole coil including the turn coil end, the turn coil end connecting the same layers of the slots in the radial direction, when the number of blanks between the pole coils is all even (including zero), or when an odd number and an even number (including zero) as the number of blanks between the pole coils are mixed.

With this configuration, it is possible to realize a rotary electric machine having a fractional slot configuration using a segment conductor, with a lap winding configuration. In this configuration, since it is possible to share the unit coil of the pole coil that occupies most of the pole coil, it is possible to reduce the manufacturing cost.

Still another characteristic configuration is that the adjacent pole coil group or the continuous-pole coil group in the second lap and subsequent laps are shifted from the adjacent pole coil group in the previous lap by one slot pitch in the direction opposite to the a-lap direction.

With this configuration, it is possible to evenly arrange the coil ends, and to achieve compactness.

Still yet another characteristic configuration is that, when layers are counted in ascending order toward an opening portion of the slot with a bottom layer of the slot as 1, as a layer-phase band arrangement in a radial direction of the slot, an even-numbered layer is configured by moving an odd-numbered layer in the circumferential direction by a predetermined slot number configured by an integer closest to the number of slots per pole, which is obtained by multiplying the number of slots per pole and phase by the number of phases, a movement direction of the even-numbered layer to the odd-numbered layer by the predetermined slot number is opposite to the a-lap direction ((a+1)-lap direction when a=0) when c is equal to or more than 4, the layer-phase band arrangement of the even-numbered layers and layer-phase band arrangement of the odd-numbered layers have the same configuration in the circumferential direction, and a phase starting end of the coil is pulled out from the slot at an end of a phase band on the a-lap direction side ((a+1)-lap direction side when a=0), the phase band in which the number of continuous slot is larger one of integers closest to the number of slots per pole and phase, and the number of continuous slots being the number of slots in which the coil sides that have the same phase and are continuous in the circumferential direction at the bottom of the slots are arranged.

With this configuration, it is possible to realize a rotary electric machine having a fractional slot configuration using a segment conductor, with a lap winding configuration.

Still yet another characteristic configuration is that the phase band including the slot for pulling out the phase starting end is a phase band (the number of continuous slots is 1 when a=0) in which the number of the odd-numbered continuous slots at the shortest distance in the circumferential direction is relatively large with respect to a phase band (the blank in which the number of continuous slots is zero when a=0) in which the number of continuous slots constituting a layer-phase band at the bottom of the slot is relatively small.

With this configuration, in the coil of the (a+1)th lap, it is possible to reduce the coil end length for electrically connecting the pole coils in the continuous-pole coils across the blank or the pole coils between the continuous-pole coils.

Still yet another characteristic configuration is that the turn coil end connecting the same layers of the slots in the radial direction in the adjacent pole coil group or the continuous-pole coil group is arranged on the outermost radial side and the innermost radial side of the slot.

As with this configuration, when the turn coil end connecting the same layers in the radial direction of the slots in the adjacent pole coil group or the continuous-pole coil group is arranged on the outermost radial side and the innermost radial side, it is possible to arrange the same layer connection turn coil end without interference with the coil ends of the adjacent pole coil group and the continuous-pole coil group, and to achieve the compactness.

Still yet another characteristic configuration is that the continuous-pole coil connection portion that sequentially and electrically connects the pole coils in the continuous-pole coils across the blanks or between the continuous-pole coils connects the layer of the slot on the outermost radial side and a layer of the slot on the innermost radial side when the number of blanks crossed by the continuous-pole coil connection portion is odd, and connects the layers of the slot on the outermost radial side with each other or the layers of the slot on the innermost radial side with each other when the number of blanks crossed by the continuous-pole coil connection portion is even (not including zero).

With this configuration, the coil ends of the continuous-pole coil group are evenly arranged, and it is possible to achieve the compactness.

Still yet another characteristic configuration is that the turn coil end other than the turn coil end connecting the same layers in the pole coil of the adjacent pole coil group, and the turn coil end in the pole coil of the continuous-pole coil group are configured, in the a-lap direction ((a+1)-lap direction when a=0), at a short-section pitch of being inclined or bent by one layer from an outer radial side of the slot to an inner radial side.

As with this configuration, when the turn coil end of the pole coil in the adjacent pole coil group and the continuous-pole coil group, which occupy most of the components, has the short-section pitch, it is possible to reduce the total coil length and reduce the manufacturing cost.

(1) The two-layer unit 11U in the above-described embodiment is not limited to four sets, and one or more sets may be provided. (2) The motor M in the above-described embodiment is not limited to the three-phase AC synchronous motor, and may be an AC motor, an induction motor, a synchronous motor, or the like having any number of phases.

This disclosure can be applied to a rotary electric machine having a fractional slot configuration having a coil configured by segment conductors.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotary electric machine comprising:
a stator that has a plurality of slots accommodating a coil having a lap winding configuration made of a segment conductor; and
a rotor that faces the stator and has a plurality of magnetic poles,
the rotary electric machine having a fractional slot configuration in which the number of slots per pole and phase, which is obtained by dividing the number of the slots of the stator by the number of phases and the number of the magnetic poles of the rotor, is more than ½, and a denominator is equal to or more than 2 in an irreducible fraction expression, wherein
when the irreducible fraction expression of the number of slots per pole and phase is set as (a+b/c) where a indicates zero or a positive integer, and b and c indicate a positive integer and b<c,
the coil for a laps is configured by an adjacent pole coil group in which pole coils adjacent to each other in a circumferential direction are electrically and sequentially connected to each other while the pole coils are arranged to be adjacent to each other over an entire circumference of the stator, the pole coils of which the number is equal to the number of magnetic poles of the rotor, and
the coil of a (a+1)th lap is configured by a continuous-pole coil group in which a continuous-pole coil is arranged in a range obtained by equally dividing the entire circumference by the number of magnetic poles/c, and the continuous-pole coils of the number of magnetic poles/c, which are adjacent to each other in the circumferential direction are sequentially and electrically connected to each other and wound, the continuous-pole coil in which b pieces of pole coils and a pole coil missing portion are adjacent to each other in no particular order, and the pole coils that are closest to each other in the circumferential direction are electrically connected, and the pole coil missing portion being made of blanks corresponding to (c-b) pieces of the pole coils, where the a laps are made in the same direction.

2. The rotary electric machine according to claim 1, wherein
the unit coil of the segment conductor includes a pair of coil sides accommodated in the two slots and one turn coil end that electrically connects the pair of coil sides to form one turn,
in the adjacent pole coil group, the pole coil including the turn coil end and the pole coil not including the turn coil end are alternately arranged in the circumferential direction, the turn coil end connecting the same layers of the slots in a radial direction, and
the continuous-pole coil group is
configured by only the pole coil not including the turn coil end that connects the same layers of the slots in the radial direction when the number of blanks between the pole coils is all odd, and
configured by the pole coil not including the turn coil end and the pole coil including the turn coil end, the turn coil end connecting the same layers of the slots in the radial direction, when the number of blanks between the pole coils is all even (including zero), or when an odd number and an even number (including zero) as the number of blanks between the pole coils are mixed.

3. The rotary electric machine according to claim 2, wherein
the adjacent pole coil group or the continuous-pole coil group in a second lap and subsequent laps are shifted from the adjacent pole coil group in a previous lap by one slot pitch in a direction opposite to an a-lap direction.

4. The rotary electric machine according to claim 2, wherein
when layers are counted in ascending order toward an opening portion of the slot with a bottom layer of the slot as 1, as a layer-phase band arrangement in a radial direction of the slot, an even-numbered layer is configured by moving an odd-numbered layer in the circumferential direction by a predetermined slot number configured by an integer closest to the number of slots per pole, which is obtained by multiplying the number of slots per pole and phase by the number of phases,
a movement direction of the even-numbered layer to the odd-numbered layer by the predetermined slot number is opposite to the a-lap direction ((a+1)-lap direction when a=0) when c is equal to or more than 4,
the layer-phase band arrangement of the even-numbered layers and layer-phase band arrangement of the odd-numbered layers have the same configuration in the circumferential direction, and
a phase starting end of the coil is pulled out from the slot at an end of a phase band on the a-lap direction side ((a+1)-lap direction side when a=0), the phase band in which the number of continuous slot is larger one of integers closest to the number of slots per pole and phase, and the number of continuous slots being the number of slots in which the coil sides that have the same phase and are continuous in the circumferential direction at the bottom of the slots are arranged.

5. The rotary electric machine according to claim 4, wherein
a phase band including the slot for pulling out the phase starting end is a phase band (the number of continuous slots is 1 when a=0) in which the number of the odd-numbered continuous slots at the shortest distance in the circumferential direction is relatively large with respect to a phase band (the blank in which the number of continuous slots is zero when a=0) in which the number of continuous slots constituting a layer-phase band at the bottom of the slot is relatively small.

6. The rotary electric machine according to claim 2, wherein
the turn coil end connecting the same layers of the slots in the radial direction in the adjacent pole coil group or the continuous-pole coil group is arranged on the outermost radial side and the innermost radial side of the slot.

7. The rotary electric machine according to claim 2, wherein
a pole coil connection portion that sequentially and electrically connects the pole coils in the continuous-pole coils across the blanks or between the continuous-pole coils
connects a layer of the slot on the outermost radial side and a layer of the slot on the innermost radial side when the number of blanks crossed by the pole coil connection portion is odd, and
connects the layers of the slot on the outermost radial side with each other or the layers of the slot on the innermost radial side with each other when the number of blanks crossed by the pole coil connection portion is even (not including zero).

8. The rotary electric machine according to claim 2, wherein
the turn coil end other than the turn coil end connecting the same layers in the pole coil of the adjacent pole coil group, and the turn coil end in the pole coil of the continuous-pole coil group are configured, in the a-lap direction ((a+1)-lap direction when a=0), at a short-section pitch of being inclined or bent by one layer from an outer radial side of the slot to an inner radial side.
